(19) United States
(12) Patent Application Publication
(10) Pub. No.: US 2026/0126537 A1
(43) Pub. Date: May 7, 2026

(54) ACOUSTIC SURVEYING USING SOUND VELOCITY PROFILE CAST FREQUENCY BASED ON A LOCAL SOLAR NOON TIME VALUE

(71) Applicant: FNV IP BV., Leidschendam (NL)

(72) Inventors: Helen Frances Stewart, Houston, TX (US); Jenny Ruiz Tixier, Dozier, AL (US); Jeffrey William Croucher, Gulfport, MS (US); Jarrot Jerome Spurlock, Lafayette, LA (US)

(21) Appl. No.: 18/936,783

(22) Filed: Nov. 4, 2024

(51) Int. Cl. G01S 7/52; G01S 7/4863; G01S 15/60; G01S 15/89

(52) U.S. Cl. CPC G01S 7/52006; G01S 7/4863; G01S 15/60; G01S 15/89

(57) ABSTRACT

Described are systems and techniques for optimizing sound velocity profile (SVP) cast frequency for solar heating effects. Location information associated with a survey vessel or acoustic survey can be obtained and used to determine a time value of local solar noon (LSN) based on the location information. A time interval can be determined corresponding to increased water column heating from solar irradiance, the time interval based on configured offsets from the time value of LSN. A first subset of a plurality of SVP measurements can be obtained outside of the time interval and using a first sampling periodicity that is longer than a second sampling periodicity used to obtain a second subset of the plurality of SVP measurements within the time interval. Unlocking insights from Geo-Data, the present invention further relates to improvements in sustainability and environmental developments: together we create a safe and livable world.

### FIELD

Aspects of the present disclosure generally relate to underwater sensing and/or acoustic surveying acquisition systems and methods of use thereof. For example, aspects of the present disclosure are related to systems and techniques for adjusting a sampling periodicity of an underway profiling device based on a local solar noon (LSN) time value and/or a main solar heating window of a surveyed water column. Unlocking insights from Geo-Data, the present invention further relates to improvements in sustainability and environmental developments: together we create a safe and liveable world.

### BACKGROUND

Marine surveying and/or other geophysical surveying performed in a marine or underwater environment can involve the collection of acoustic positioning and/or bathymetry data. Bathymetry data can be used for the measurement and study of the seafloor (or the floors of other bodies of water in which the bathymetry data is collected). For example, bathymetry data can be used to map depth contours of the seafloor, similar to the elevation contours mapped by topography data collected for land-based environments, while acoustic positioning data can be used to track items or objects in the water such as towed scientific instruments or uncrewed underwater vehicles (UUVs), among various others. Sonar bathymetry surveys can use multibeam echosounders and/or various other sonars or acoustic sensors to map underwater terrain based on emitting multiple beams (e.g., sound waves) that travel through the water column, reflect off the seafloor, and travel once again through the water column on a return path back to the sonar head. The time taken for these sound waves to travel to the seafloor and reflect back can be used to calculate depth, by using the speed of sound in the water column to convert the time value into a distance value. Accurate depth or distance determination in a sonar bathymetry survey or acoustic positioning operations can require accurate information characterizing the sound speed within the water column, and sound waves may refract according to variations in water density, temperature, salinity, etc., within the water column. Errors or inaccuracies in the sound speed information used to process sonar or other acoustic survey data can result in distortions of the calculated angles and ranges of the sonar beams. Such distortion can vary with the sonar beam angle, with the depth inaccuracies increasing with the beam angle.

Sound speed errors in bathymetric surveys and/or acoustic positioning operations can correspond to environmental factors such as temperature and salinity gradients. For example, in a layered or stratified water column, different layers can vary in sound speed, particularly when a thermocline is present. Thermoclines may occur when surface water layers absorb heat or are otherwise heated at a greater rate than deeper water layers. The surface heating effect can create rapid temperature changes at relatively shallow water depths within the surface or near-surface layers of the water column, and increased temperature gradients along the depth of the water column. These temperature differences correspond to increases in the sound speed in the warmer upper layer(s) relative to the cooler lower layer(s) of the water column, causing sound waves to bend and refract away from the expected straight-line path. The “afternoon effect” can refer to errors in acoustic instrument data caused by sound speed changes that result from transient thermoclines formed under calm, sunny conditions. The afternoon effect can correspond to solar heating of the upper and/or surface ocean layers in the absence of mixing (e.g., due to calm conditions with low wind), which creates a temperature gradient (e.g., transient thermocline) near the surface.

MBES and other sonar transceivers are commonly operated within this same surface or near-surface layer of the water column, and the transient thermocline or temperature gradient associated with the afternoon effect refracts acoustic waves downward, negatively impacting the sonar performance as both transmitted and reflected (e.g., outgoing and incoming) sonar pulses are directed away from the sonar array due to refraction at the thermocline. Transient thermoclines may develop and dissipate according to various meteorological and oceanographic conditions, including solar radiation intensity, wind speed, cloud cover, tidal influences, etc., and the sound speed profile within a water column may be highly variable in magnitude and/or rate of variation.

There is thus a need to address at least one of the problems described above by providing a solution for uncertainties in the sound speed profile within a water column to more accurately translate acoustic data into distance data.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some examples, systems and techniques are described for adjusting a sampling periodicity of an underway profiling device based on a local solar noon (LSN) time value and/or a main solar heating window of a surveyed water column. For example, a method can include: obtaining location information associated with one or more of a survey vessel or an acoustic survey associated with the survey vessel; determining a time value of solar noon associated with the location information, wherein the time value of solar noon is determined based on the location information; determining a time interval corresponding to increased water column heating from solar irradiance of a water column beneath the survey vessel, wherein the time interval is determined using one or more configured offsets from the time value of solar noon; and performing the acoustic survey to obtain a plurality of sonar measurements and a plurality of sound velocity profile measurements within the water column, wherein: a first subset of the plurality of sound velocity profile measurements is obtained outside of the time interval and using a first sampling periodicity; and a second subset of the plurality of sound velocity profile measurements is obtained within the time interval and using a second sampling periodicity, wherein the second sampling periodicity is shorter than the first sampling periodicity.

In some aspects, the method further comprises: determining updated location information associated with one or more of the survey vessel or the acoustic survey; determining an updated time value of solar noon based on the updated location information; and updating the time interval using the updated time value of solar noon.

In some aspects, the updated time value of solar noon is determined in response to a difference between the updated location information and the location information being greater than or equal to two degrees of longitude.

In some aspects, a difference between the updated time value of solar noon and the time value of solar noon is greater than or equal to the second sampling periodicity.

In some aspects, the second sampling periodicity is less than or equal to half of the first sampling periodicity.

In some aspects, performing the acoustic survey includes: increasing, in response to a start of the time interval, a quantity of sound velocity profile measurements obtained per hour from a first number to a second number; and decreasing, in response to an end of the time interval, the quantity of sound velocity profile measurements obtained per hour from the second number to the first number, wherein the first number corresponds to the first sampling periodicity, and wherein the second number corresponds to the second sampling periodicity.

In some aspects, the plurality of sonar measurements are obtained using one or more sonar transceivers coupled to a hull of the survey vessel and positioned within the water column; and the plurality of sound velocity profile measurements are obtained using an underway profiler deployed from the survey vessel into the water column, wherein the underway profiler is deployed corresponding to the first sampling periodicity outside of the time interval and is deployed corresponding to the second sampling periodicity within the time interval.

In some aspects, the one or more sonar transceivers comprise one or more multibeam echosounder (MBES) transducer arrays; and the underway profiler comprises an underway sound velocity profiler (SVP), preferably a towed SVP.

In some aspects, the location information is indicative of at least a longitude of a geographic location corresponding to one or more of the survey vessel or the acoustic survey, and wherein the time value of solar noon corresponds to the longitude.

In some aspects, the time value of solar noon further corresponds to one or more of a latitude of the geographic location or a configured date value, wherein the configured date value comprises: an acquisition date associated with the location information, a future date associated with the acoustic survey, or a pre-determined date.

In some aspects, the pre-determined date corresponds to one or more of: a particular solar position of the Sun or an equinox position of the Sun In some aspects, the time interval is determined using a first offset and a second offset from the time value of solar noon, the first offset and the second offset included in the one or more configured offsets; the first offset is indicative of a difference between the time value of solar noon and a start of the time interval; and the second offset is indicative of a difference between an end of the time interval and the time value of solar noon.

In some aspects, the first offset and the second offset are different.

In some aspects, the second offset is greater than the first offset.

In some aspects, a respective size for each of the one or more configured offsets is determined based on one or more of: a latitude associated with the location information, a date or a season corresponding to the time value of solar noon, or depth information of the water column.

In some aspects, the time interval extends from at least one hour before the time value of solar noon to at least two hours after the time value of solar noon.

In some aspects, the time interval comprises a particular portion of a day corresponding to a main solar heating window (MSHW) for the water column beneath the survey vessel, and wherein the MSHW is based on one or more of: a peak solar irradiance of the water column occurring during the particular portion of the day; a maximum potential for solar energy absorption within the water column occurring during the particular portion of the day; or a maximum rate of temperature change associated with the water column occurring during the particular portion of the day.

In some aspects, the method further comprises determining, based on the time value of solar noon, an expected rate of change in one or more characteristics of the water column; and determining one or more of the time interval or the second sampling periodicity based on the expected rate of change.

In some aspects, determining the expected rate of change comprises determining a derivative of water surface temperature within the water column, wherein the derivative is determined with respect to a time of day.

In some aspects, each sound velocity profile measurement of the plurality of sound velocity profile measurements is obtained using either the first sampling periodicity or the second sampling periodicity.

In some aspects, one or more of the plurality of sound velocity profile measurements are obtained using respective sampling periodicities that are shorter than the first sampling periodicity and longer than the second sampling periodicity.

In some aspects, the method further comprises processing the plurality of sonar measurements to generate a corresponding plurality of refraction corrected sonar measurements, wherein generating the corresponding plurality of refraction corrected sonar measurements includes: processing a first subset of the plurality of sonar measurements using the first subset of the plurality of sound velocity profile measurements, to thereby generate a first subset of the corresponding plurality of refraction corrected sonar measurements; and processing a second subset of the plurality of sonar measurements using the second subset of the plurality of sound velocity profile measurements, to thereby generate a second subset of the corresponding plurality of refraction corrected sonar measurements.

In some aspects, the first subset of the plurality of sonar measurements and the first subset of the plurality of sound velocity profile measurements are obtained outside of the time interval; and the second subset of the plurality of sonar measurements and the second subset of the plurality of sound velocity profile measurements are obtained within the time interval.

In another illustrative example, a system is provided, the system comprising at least one processor and a memory storing instructions which, when executed by the at least one processor, cause the at least one processor to: obtain location information associated with one or more of a survey vessel or an acoustic survey associated with the survey vessel; determine a time value of solar noon associated with the location information, wherein the time value of solar noon is determined based on the location information; determine a time interval corresponding to increased water column heating from solar irradiance of a water column beneath the survey vessel, wherein the time interval is determined using one or more configured offsets from the time value of solar noon; and perform the acoustic survey to obtain a plurality of sonar measurements and a plurality of sound velocity profile measurements within the water column, wherein: a first subset of the plurality of sound velocity profile measurements is obtained outside of the time interval and using a first sampling periodicity; and a second subset of the plurality of sound velocity profile measurements is obtained within the time interval and using a second sampling periodicity, wherein the second sampling periodicity is shorter than the first sampling periodicity.

In some aspects, the instructions further cause the at least one processor to: compare a current time value to the determined time value of solar noon; and control, based on the comparison, a winch system attached to the survey vessel and configured to deploy a towed sound velocity profiler (SVP) from the survey vessel into the water column, wherein the instructions cause the at least one processor to control the winch system to: deploy the towed SVP using the first sampling periodicity in response to the comparison indicating that the current time value is outside of the time interval; and deploy the towed SVP using the second sampling periodicity in response to the comparison indicating that the current time value is within the time interval.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates a perspective view of a survey vessel imaging system that can be used to perform underwater profiling and/or acoustic survey operations to obtain a plurality of sonar measurements and a plurality of sound velocity profile measurements, in accordance with some examples;

FIG. 2A is a graph depicting a plurality of MBES position tracklines obtained at different times of day and further depicting a corresponding surface sound speed measurement at the MBES head for each trackline, in accordance with some examples;

FIG. 2B is a graph depicting another example of MBES position tracklines versus surface sound speed measured at the MBES head, over time, in accordance with some examples;

FIG. 3 is a graph illustrating an example time-series plot of surface sound speed measurements within a water column over a period of time corresponding to acoustic survey operations performed within the water column, in accordance with some examples;

FIG. 4 is a graph illustrating another example time-series plot of surface sound speed measurements within a water column over a period of time corresponding to acoustic survey operations performed within the water column, in accordance with some examples;

FIG. 5 is a graph illustrating an example of a main solar heating window (MSHW) corresponding to local solar noon (LSN) time values during a period of time corresponding to acoustic survey operations performed within a water column, in accordance with some examples;

FIG. 6 is a diagram illustrating example graphs of an MBES swath angle grid with and without performing additional sound velocity profile casts (e.g., measurements) during the MSHW corresponding to the local solar noon time value, and further illustrating difference graphs determined therebetween, in accordance with some examples;

FIG. 7 is a diagram illustrating example graphs of solar elevation angle, solar angular velocity, and solar angular acceleration associated with a threshold corresponding to a peak solar heating effect within the MSHW, in accordance with some examples;

FIG. 8 is a diagram illustrating example graphs depicting seasonality-based changes in a solar heating window (e.g., the MSHW) for a body of water or water column, in accordance with some examples;

FIG. 9 is a flow diagram illustrating an example of a process for performing an acoustic survey using a sampling periodicity of sound velocity profile measurements adjusted according to a time interval determined based on the local solar noon time value, in accordance with some examples; and

FIG. 10 is a block diagram illustrating an example of a computing system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

It will be appreciated that for simplicity and clarity of illustration, where appropriate, reference numerals have been repeated among the different figures to indicate corresponding or analogous elements. In addition, numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Systems, apparatuses, processes (also referred to as methods), and computer-readable media (collectively referred to as “systems and techniques”) are described herein that can be used to adjust and/or optimize a sampling periodicity of an underway profiling device used to obtain sound velocity profile measurements during an acoustic survey, where the adjustment in sound velocity profile sampling periodicity is based on determining a local solar noon (LSN) time value corresponding to a main solar heating window of the surveyed water column. In some aspects, the systems and techniques can be used to determine a time interval or window within a larger day or other period of time (e.g., such as 24 hours, etc.), such that the determined time interval corresponds to peak solar heating from the “afternoon effect” and/or corresponds to the development or presence of a transient thermocline within the surface or near-surface layers of the water column.

In some embodiments, the determined time interval corresponding to afternoon effect solar heating and transient thermoclines may be referred to herein as a “main solar heating window” (MSHW). As will be described in greater detail below, in at least one illustrative example, the systems and techniques can be configured to determine the MSHW based on and/or relative to a local solar noon time that is determined for a given location or input of location information. For example, the local solar noon (LSN) time can be determined for the location of a survey vessel, or a location associated with a survey vessel (e.g., such as a location within a survey area of an acoustic survey performed by the vessel, etc.).

Local solar noon, or LSN, can refer to the specific moment (e.g., time) during a solar day when the Sun crosses the local meridian of a given geographical location, reaching its highest apparent position in the sky. This event occurs when the Sun is directly overhead at the local meridian, which is also seen to be the solar position resulting in the shortest (e.g., minimal) shadow cast by an object. Local solar noon may also be referred to as “solar noon” for a particular location, as the timing of LSN is influenced by the observer's longitude and may further vary corresponding to the Earth's axial tilt and elliptical orbit. For example, “local” solar noon may refer to the fact that observers at different locations may each experience solar noon at different times on the same day, as well as the fact that an observer at the same location may experience solar noon at different times on different days/during different seasons. For a given location, the LSN or solar noon occurs when the Sun is at its highest elevation and at a 180 degree azimuth (angular measurement from true north). The apparent motion of the Sun (e.g., the angular acceleration of the Sun) is minimized at and around the time of the LSN, and accordingly, the LSN or solar noon event for a given location can be seen to correspond to the time (e.g., within a given day) of peak solar heating and solar irradiance at the given location.

Further aspects of the disclosure are described below, with reference to the figures.

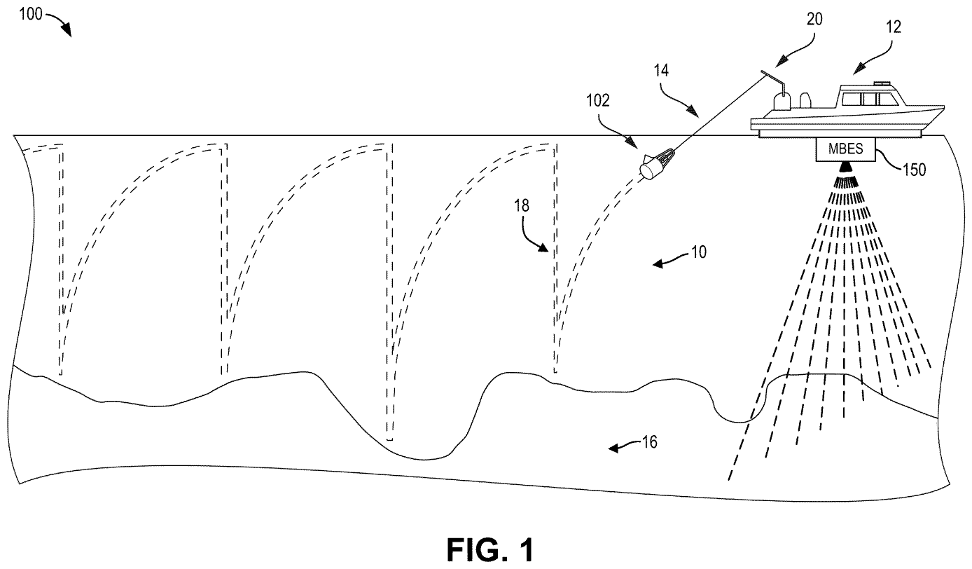

For example, FIG. 1 illustrates a perspective view of an imaging system 100 that can be used to perform underwater profiling and/or acoustic survey operations to obtain a plurality of sonar measurements and a plurality of sound velocity profile measurements, in accordance with some examples. For example, the imaging system 100 can be an acoustic surveying or bathymetric imaging system associated with one or more survey vessels, such as the survey vessel 12 illustrated in FIG. 1. In some examples, the imaging system 100 can be used for performing underwater profiling, such as collecting vertical water column profiles 18, within a body of water 10 (e.g., an ocean or sea, lake, etc.). The survey vessel 12 can be located on the surface of the body of water 10, such that the vertical water column profiles 18 are obtained for a water column beneath the survey vessel 12.

As illustrated, the acoustic imaging system 100 includes a survey vessel 12, shown here as a surface vessel traveling on the surface of the body of water 10. The survey vessel 12 can be provided by various vessels or vessel types, including boats, towing vessels, towing vehicles, unmanned surface vessels, etc. The survey vessel 12 can be configured with a multibeam echosounder (MBES) 150 and/or various other type(s) of sonar and/or acoustic sensor(s) for obtaining acoustic survey or bathymetric data corresponding to a seafloor or other underwater surface or object(s) (e.g., including acoustic positioning data that may be used for or otherwise associated with tracking objects located or moving within the water column, including but not limited to examples such as towed scientific instruments, uncrewed underwater vehicles, etc.). The MBES 150 can be mounted to a hull of the survey vessel 12, can be deployed over the side of the survey vessel, can be deployed from a moon pool of the survey vessel 12, can be towed by the survey vessel 12 (e.g., can be a towed apparatus deployed by and from the survey vessel 12), etc. In some cases, the MBES 150 can be provided in a gondola apparatus attached to a hull of the survey vessel 12, such that the MBES 150 is submerged below the surface of the body of water 10. For example, a gondola can be provided as a construction mount and housing for an MBES sonar or MBES transducer array, where the gondola may be mounted or coupled underneath or otherwise vertically below the survey vessel 12. As contemplated herein, the MBES component 150 may additionally include, or may alternatively comprise, various other types of sonars and/or acoustic sensors, without departing from the scope of the present disclosure. For example, the MBES 150 can include or comprise, and/or the survey vessel 12 may include or be associated with, various active acoustic sensors, sonars, and/or echosounders, which can include one or more of a single-beam or split-beam echosounder (SBES), MBES, a sidescan sonar (SSS), a synthetic aperture sonar (SAS), a scanning sonar, a volumetric scanning sonar, etc., some or all of which may be implemented as single-beam/single-frequency sonar systems, and/or can be implemented as multi-beam/multi-frequency sonar systems.

In one illustrative example, the survey vessel 12 includes both an acoustic sensor or sonar array (e.g., such as MBES 150) and an underway profiler device, such as the towed sound velocity profiler (SVP) 102 illustrated in FIG. 1. The survey vessel 12 can be configured to perform acoustic surveys and/or acoustic surveying operations based on performing sonar scans using the MBES 150 while simultaneously deploying, at one or more configured sampling rates or sampling periodicities, the towed SVP 102 from the survey vessel 12 to obtain a sound velocity profile for the vertical water column profiles 18.

As illustrated in the example of FIG. 1, the imaging system 100 can further include a tow cable 14 (e.g., tether) that attaches, couples, affixes, etc., the towed SVP 102 to the survey vessel 12. In some embodiments, the tow cable 14 can be a reel- or drum-mounted and/or winch-driven cable that is provided on a deck surface of the survey vessel 12, or is otherwise attached to the survey vessel 12. The towed SVP 102 may also be referred to as an underway profiler, an underway profiler device, or an underway profiler apparatus, as noted previously above. As used herein, the towed SVP 102 can also be referred to as a towed sensing apparatus 102. To deploy the towed SVP 102 to perform underwater profiling of the sound speed (e.g., collecting vertical water column profiles 18), one end of the tow cable 14 is connected (e.g., removably coupled) to the survey vessel 12 and the opposite end of the tow cable 14 is connected (e.g., removably coupled) to the towed SVP 102. Subsequently, the towed SVP 102 can be lowered into the body of water 10 to perform sound speed sampling.

As used herein, the deployment of the underway sound velocity profiler (SVP) 102 to obtain sound speed measurements or a sound velocity profile within the water column may also be referred to interchangeably as a “cast,” performing a “cast,” “casting,” and/or “cast acquisition,” etc. When the towed SVP 102 is deployed (e.g., collecting a vertical water column profile 18), the configuration (e.g., mass, hydrodynamic surface(s), etc.) of the towed SVP 102 causes the SVP 102 to travel substantially vertically through a water column (e.g., advance substantially downward towards the seafloor 16). During descent, the towed SVP 102 can be stopped at a predetermined depth, before contacting the seafloor 16. A winch 20 (e.g., a winch 20 coupled to the survey vessel 12 and used to wind/unwind or retract/extend the tow cable 14) is used to return the towed SVP 102 to the surface (e.g., above the body of water 10). In this manner, the towed SVP 102 can be lowered and raised from the survey vessel 12 (e.g., in a “yo-yo” movement) to collect vertical water column profiles 18.

In some aspects, the data collection operations performed by the survey vessel 12 can be partially or fully automated, including data collection operations to obtain a plurality of sonar measurements using the MBES 150 and/or data collection operations to obtain a plurality of sound velocity profile measurements using the underway profiler/towed SVP 102. For example, the winch 20 can be an automated winch for deploying and retrieving the towed SVP apparatus 102 from the body of water 10. The SVP 102 can, in some examples, be configured to provide a real-time data feed including or indicative of sound speed measurement data and/or sound velocity profiles collected by the SVP 102. The winch 20 and an on-board depth sensor can be used to control the depth of travel of the SVP 102 within the water column and/or body of water 10 (e.g., stopping the towed SVP 102 at a predetermined depth before contacting the seafloor 16, etc.).

For instance, the SVP 102 can include one or more on-board depth sensors for obtaining depth information associated with the currently deployed depth of the SVP apparatus 102. Based on determining that the currently deployed depth of the SVP apparatus 102 is greater than a pre-determined threshold (e.g., a maximum deployment depth that is less than the seafloor depth), the depth of travel of the towed SVP apparatus 102 can be halted prior to the towed SVP apparatus 102 contacting the seafloor 16. In some embodiments, the one or more on-board depth sensors can include a pressure sensor (e.g., water pressure information from the pressure sensor can be used to determine the currently deployed depth of the towed SVP apparatus 102 and/or sensed pressure values can be compared to known pressure values associated with particular water depths, etc.). In some aspects, the tow cable 14 is a heavy, double armored steel tow cable. In other words, the tow cable 14 is not a neutral weight-based Kevlar type tow cable. The heavy, double armored steel tow cable can increase the combined mass of the towed sensing apparatus 102 and the tow cable 14. Moreover, the heavy, double armored steel tow cable can improve the durability of the towed sensing apparatus 102. For example, when it is deployed (e.g., collecting a vertical water column profile 18), the towed sensing apparatus 102 is often near other towed equipment and/or fishing equipment, which can chaff and/or sever a Kevlar type tow cable.

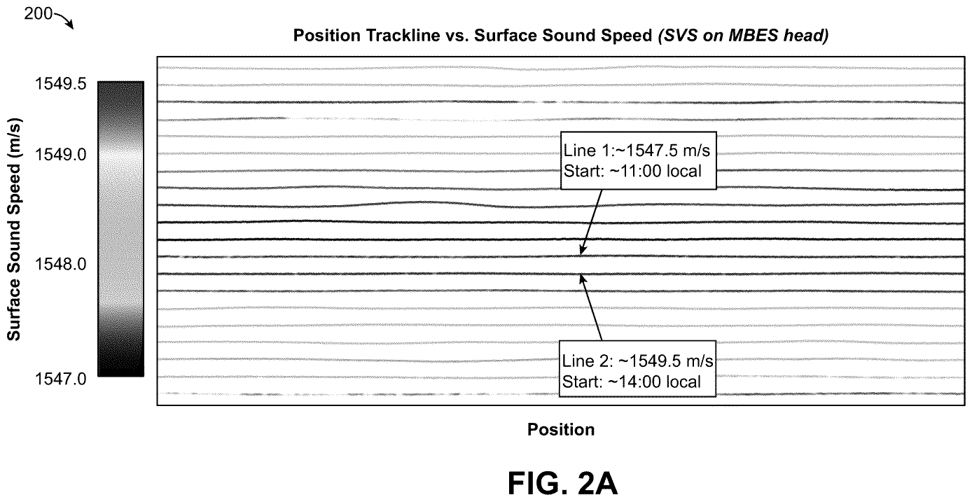

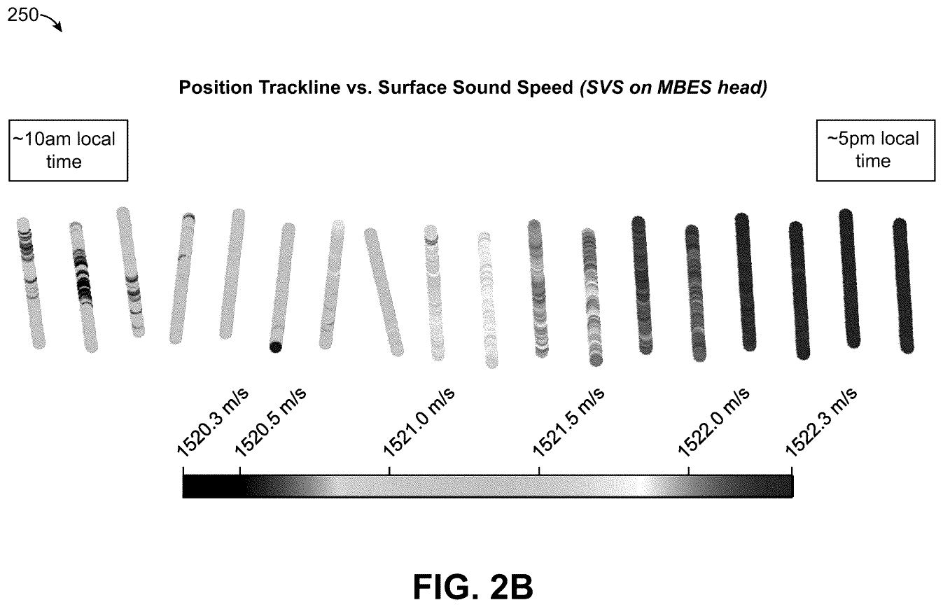

FIG. 2A illustrates a graph 200 depicting a plurality of MBES position tracklines obtained at different times of day during the same acoustic survey operation, in accordance with some examples. In particular, the plurality of MBES position tracklines are shown in the example of FIG. 2A as the plurality of approximately horizontal lines, each representing a different measurement swath line of the MBES survey, and each associated with a respective measurement start time. For example, a first MBES position trackline, labeled “Line 1” in FIG. 2A, is associated with a start time of approximately 11:00 local time. A second MBES position trackline, labeled “Line 2” in FIG. 2A, is associated with a start time of approximately 14:00 local time, etc.

In some aspects, FIG. 2A represents a trackline plot of easting, northing, and speed of sound information encoded for each the respective plurality of MBES position tracklines. The horizontal axis represents position, the vertical axis represents the water surface sound speed (in meters per second, m/s), and the shading of each trackline according to the legend shown at the left of the graph 200 in FIG. 2A represents the surface sound speed information for the correspondingly shaded tracklines. In some examples, the surface sound speed information depicted in graph 200 may be obtained from a sound velocity sensor (SVS) and/or miniature sound velocity sensor (mini SVS) that is included in or on, or otherwise attached to, the multibeam head used to obtain the sonar measurements. For example, an SVS or mini SVS can be included in or otherwise attached to the MBES 150 of FIG. 1, etc. In such examples, the SVS or mini SVS used to measure the surface sound speed in the water column can be different from the underway profiler or SVP 102 that is used to measure the sound speed at different depths within the water column (i.e., where the measured sound velocity profile can include a surface sound speed measurement for the surface and near-surface layers of the water column, and can additionally include respective sound speed measurements for intermediate and deeper layers of the same water column, below the surface layer(s) measured by the multibeam head SVS).

MBES tracklines corresponding to measurements obtained within the same survey area (e.g., same approximate geographic location, region, etc.) and on the same day can experience relatively large variations in the surface sound speed of the water column, based on the particular time of day when each MBES trackline was obtained. For example, the ‘Line 1’ trackline in FIG. 2A was started at 11:00 local time and was associated with a surface sound speed of approximately 1,547.5 m/s at the SVS on the MBES sonar head. The ‘Line 2’ trackline in FIG. 2A was started approximately three hours later, at 14:00 local time, and was associated with a surface sound speed of approximately 1,549.5 m/s.

The difference of approximately 2 m/s in surface sound speed within the water column between the MBES measurements obtained for Line 1 at 11:00 and the MBES measurements obtained for Line 2 at 14:00 can be a non-trivial source of error for the MBES sonar survey. As noted previously above, sound speed errors in bathymetric surveys and/or acoustic positioning operations (e.g., subsurface positioning operations) can correspond to environmental factors such as temperature gradients (as well as other water column characteristics, such as salinity gradients, etc.). For example, in a layered or stratified water column, different layers can vary in sound speed, particularly when a thermocline is present. Thermoclines may occur when surface water layers absorb heat or are otherwise heated at a greater rate than deeper water layers. The surface heating effect can create rapid temperature changes at relatively shallow water depths within the surface or near-surface layers of the water column, and increased temperature gradients along the depth of the water column. These temperature differences correspond to increases in the sound speed in the warmer upper layer(s) relative to the cooler lower layer(s) of the water column, causing sound waves to bend and refract away from the expected straight-line path. The “afternoon effect” can refer to errors in acoustic instrument data (e.g., measurements obtained from an MBES, sonar array, acoustic sensor array, etc.), where the errors are caused by or otherwise correspond to the sound speed changes in water that result from transient thermoclines formed under calm, sunny conditions. The afternoon effect can correspond to solar heating of the upper and/or surface ocean layers in the absence of mixing (e.g., due to calm conditions with low wind), which creates a temperature gradient (e.g., transient thermocline) near the surface.

The sound speed in water increases as the water heats (e.g., is warmed), and the trackline plot 200 of FIG. 2A illustrates an example of the afternoon effect where daytime solar heating causes an increase in sound speed at the surface of the water column, with lower surface sound speeds corresponding to cooler water temperatures and tracklines with start times relatively early in the day (or into the evening hours when the water surface begins to cool), and with higher surface sound speeds corresponding to warmer water temperatures and tracklines with start times in the middle of the day and the afternoon. This afternoon effect of solar heating of the upper ocean layers is a challenging environmental phenomena that can commonly affect the sound velocity profile of a water column. It is noted that as used herein, the terms “sound speed” and “sound velocity” are used interchangeably in the context of sound in water.

FIG. 2B is a graph 250 depicting another example of MBES position tracklines versus surface sound speed measured at the MBES head, in accordance with some examples. In the example of FIG. 2B, time is shown on the horizontal axis, with MBES position tracklines along the vertical axis. In particular, the graph 250 of FIG. 2B illustrates the change in surface sound speed measurements observed over the course of a day for MBES acoustic survey operations. The time progression begins from the MBES trackline shown at the far left of graph 250, corresponding to an acquisition start time of approximately 10 am local time, and continues until the MBES trackline shown at the far right of graph 250, corresponding to an acquisition start time of approximately 5 pm local time. As in the example of FIG. 2A, the graph 250 of FIG. 2B also illustrates the surface sound speed as measured by an SVS on the MBES head, with the surface sound speed value for each trackline indicated by the shading of the trackline according to the legend shown below the graph 250.

As can be clearly seen in the graph 250 of FIG. 2B, the sound speed in the surface or near-surface layers of the water column (e.g., at the depth of the SVS on the MBES head, typically positioned just below the hull of the survey vessel, etc.) is seen to increase as the day/morning progresses into the afternoon. Indeed, the average sound speed measurement over the length of each individual trackline is seen in FIG. 2B to be increasing for each successive trackline (e.g., a continuous increase in the measured surface sound speed for later trackline acquisition start times).

As the sound speed in water increases with the water temperature, this creates a corresponding sound speed gradient (e.g., a transient thermocline) that can refract acoustic rays downward, away from their intended paths. The severity of this effect depends on the balance between solar heating and wind-driven mixing—under low wind conditions (e.g., in the range of approximately 5-15 knots, etc.), the lack of mixing allows solar heating to create strong temperature gradients, while higher winds may promote mixing that can prevent significant gradients from forming or otherwise reduce the strength or size of the transient thermocline that does manage to form. The structure of these transient thermoclines often takes on a characteristic “half-section of a wineglass” appearance, with the strongest gradients occurring in the upper 10-20 meters of the water column. The development and strength of these thermoclines may correspond to several environmental factors including wind speed, solar radiation intensity, cloud cover, water turbidity, and latitude, among various others. The effect can become particularly problematic for sonar systems when the sound speed at the sonar transducer depth exceeds the sound speed at the bottom of the mixed layer, which can lead to significant refraction of acoustic beams and consequent errors in depth measurements. Sound speed-related sonar errors may become magnified or increased in severity as the effect is especially impactful on outer beams at high (e.g., large) beam angles, where the effect of sound speed errors is magnified due to the longer ray paths through the varying sound speed structure.

Inadequate sound speed profile sampling can be a major contributing factor to MBES or other acoustic survey projects exceeding a maximum error tolerance or threshold, and can additionally be a major contributing factor in the occurrence of leakage from extra time (e.g., delays) needed for performing additional data processing and/or post-processing in an attempt to correct the sonar measurement errors induced by the sound speed variation within the water column during the acquisition of the sonar survey measurement data. The ocean and relatively shallow-water nearshore environments (e.g., depths of approximately 20 meters or less) are energetic and dynamic environments, and the speed of sound in water varies greatly in these regions, in both the temporal and spatial domains. As noted previously above, temporal variations in the speed of sound in water can correspond to environmental conditions and solar irradiance of the water, such as that associated with daytime heating and/or the afternoon effect. Spatial variations in the speed of sound in water can correspond to stratification of the water column into different layers having different physical properties, behaviors, characteristics, conditions, etc.

There is a need for systems and techniques that can be used to capture and compensate for (e.g., correct for) the variability in the speed of sound in water, and more generally, the variability in the sound speed structure within the surveyed area and depths of the water column during an MBES or other acoustic surveying operation. For example, acoustic surveying operations that are performed based on the variability in the speed of sound in water can be performed to obtain higher quality and more accurate sonar data, with a reduced post-processing workload further increasing the efficiencies gained.

There is a further need for systems and techniques that can be used to assist a survey vessel crew in determining and planning the timing of when to take sound velocity profile casts (e.g., when to measure the sound velocity profile of the water column during an acoustic survey), and/or systems and techniques that can be used to automatically or autonomously determine and plan the timing of the sound velocity profile casting while the survey vessel is underway during an acoustic survey. For example, the determination and planning of the timing of when to take the sound velocity profile casts can include an indication of the time frequency or sampling periodicity to perform casting (e.g., number of casts per hour, time interval between successive casts, etc.). Advantageously, the systems and techniques described herein can be used for the determination and planning of sound velocity profile casting or measurement, where the determination and planning is based on empirical data such as location information, astronomical calculations, and/or real-time and/or modeled oceanographic parameters for survey vessels equipped with multibeam echosounders and underway sound velocity profiling systems. Additionally, in examples of a semi-autonomous or fully autonomous survey vessel (e.g., including uncrewed survey vessels, etc.), there may be a need for a semi-automated or automated cast acquisition routine that can be implemented to minimize the need for human intervention during the data acquisition phase.

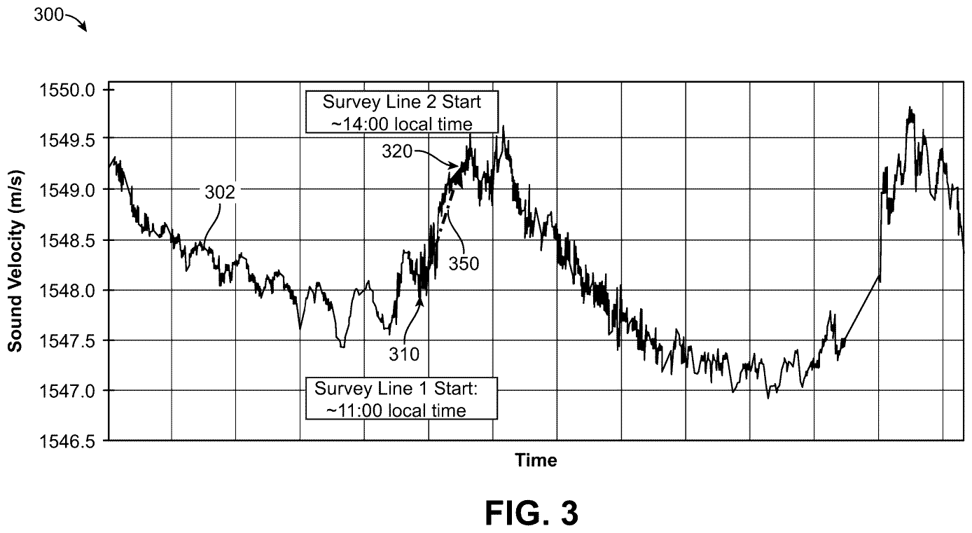

FIG. 3 is a graph illustrating an example time-series plot 300 of surface sound speed measurements within a water column over a period of time corresponding to acoustic survey operations performed within the water column, in accordance with some examples. In one illustrative example, FIG. 3 depicts a time-series plot 300 corresponding to the same MBES and sound speed in water measurements that are also represented in the trackline plot 200 of FIG. 2A.

For example, the time-series plot 300 of FIG. 3 illustrates the water sound velocity curve 302 at the MBES head over time, with sound velocity represented along the vertical axis (e.g., in m/s), and with time represented along the horizontal axis. In one illustrative example, the survey line 1 acquisition starting point 310 (e.g., a start time of 11:00 local time) depicted in FIG. 3 can be the same as the ‘Line 1’ shown in FIG. 2A. Likewise, the survey line 2 acquisition starting point 320 (e.g., a start time of 14:00 local time) depicted in FIG. 3 can be the same as the ‘Line 2’ shown in FIG. 2A.

As shown in the example time-series plot 300 of FIG. 3, the water sound velocity curve 302 measured by the sound velocity sensor at the MBES head can exhibit relatively large and/or significant fluctuations over time, with a larger trend of a gradual rise and fall combined with more localized spikes and fluctuations in the instantaneous or near-instantaneous values of the measured sound velocity.

In some aspects, the rate of change in the water sound velocity curve 302 is represented by the slope line 350, which is taken between the survey line 1 acquisition starting point 310 at 11:00 local time, and the survey line 2 acquisition starting point 320 at 14:00 local time. The slope line 350 can be the slope or gradient of the water sound velocity curve 302 over the three hour period starting at 11:00 local time and ending at 14:00 local time. The value of the slope or gradient associated with slope line 350 represents the rate of change in the speed of sound in water (e.g., the rate of change/derivative of the sound speed or sound velocity measured by the SVS at the MBES head, and more generally, the rate of change/derivate of the sound speed or sound velocity just below the surface of the water column).

The rate of change in the speed of sound in water is at a peak during the 11:00-14:00 local time window corresponding to the slope line 350 between the two MBES acquisition starting points 310 and 320. Prior to the first acquisition starting point 310 at 11:00 local time, the water sound velocity curve 302 exhibits a gradual decrease, corresponding to the gradual cooling of the water during the overnight hours represented starting from the far left on the horizontal axis of graph 300 of FIG. 3. The maximum rate of change in the speed of sound in the water occurs along the slope line 350 between the acquisition points 310 and 320, with the increase in sound speed beginning prior to acquisition point 310, albeit at a slower rate. Following the peak increase in the speed of sound in water during the maximum rate of change along the slope line 350, an approximately two hour period is observed where the sound velocity remains more or less steady, e.g., beginning from the MBES acquisition point 320 at 14:00 local time and extending onwards into the afternoon hours. Following the approximately two hour period of more or less steady sound velocity in the water, a slow/gradual decrease in the measured sound velocity is seen throughout the overnight hours, corresponding to the slow/gradual decrease in the water temperature during the overnight hours. This pattern of warming and cooling, and increasing and decreasing sound speed in the water, may be observed day after day and/or on a near-daily basis, with the peak rate of change in water velocity during the time period 350 corresponding to the peak solar irradiance and solar heating of the water surface layers due to the afternoon effect occurring in this same time period 350.

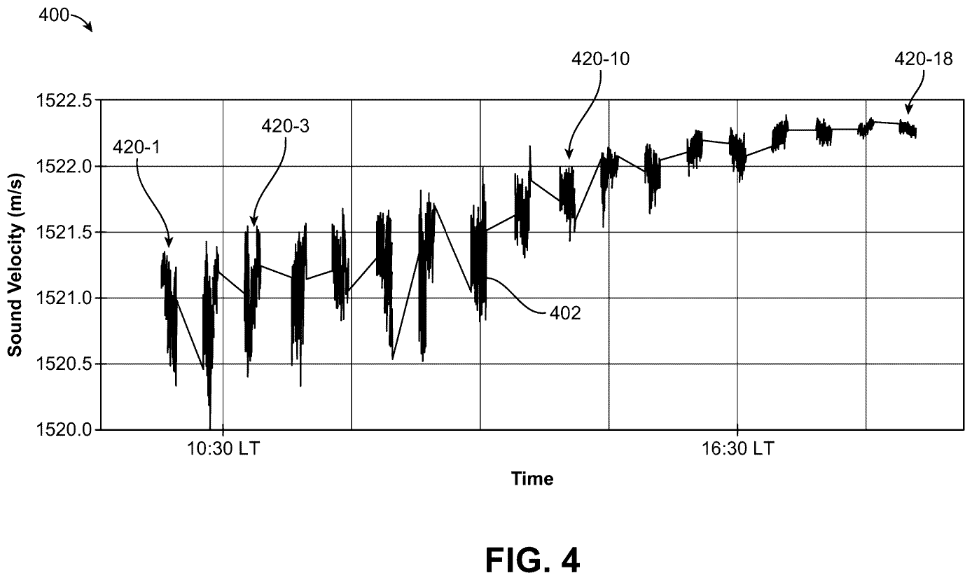

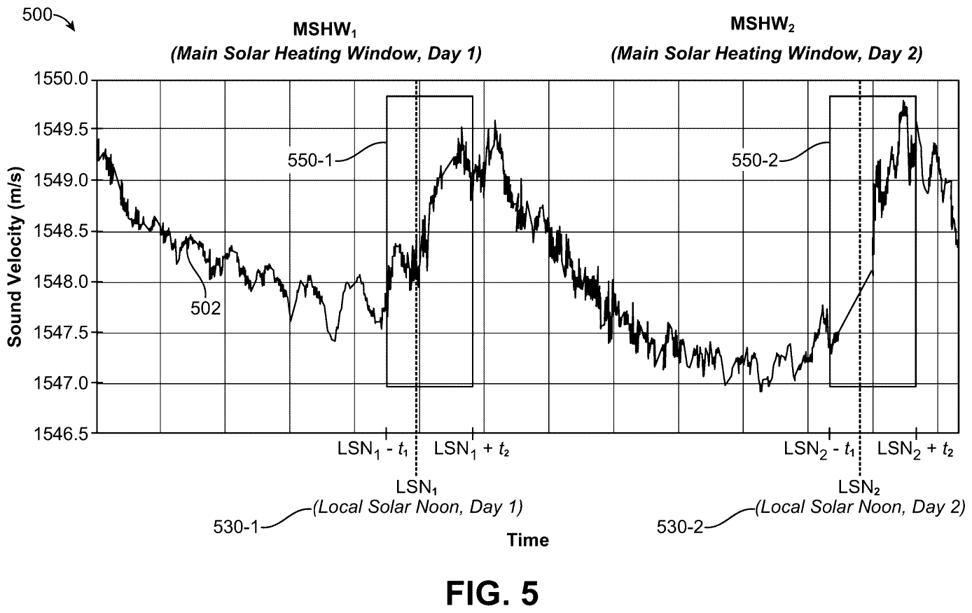

FIG. 4 is a graph illustrating another example time-series plot 400 of surface sound speed measurements at the multibeam head against time (e.g., over the course of a day or 24 hour period, etc.), in accordance with some examples. In the example time-series plot 400 shown in FIG. 4, the speed of sound in water was measured by an SVS with the nominal draft at the multibeam head equal to 5 meters below the water line (e.g., 5 meters below the water surface). As was the case in the example of FIG. 5, the time-series plot 400 of FIG. 4 likewise exhibits a trend where the speed of sound at the 5 meter nominal draft depth increases over time, as the day progresses from morning into afternoon and early evening. In the time-series plot 400, the portion of the plotted sound velocity curve 402 shown on the left of the horizontal time axis corresponds to approximately 10:30 local time, while the portion of the plotted sound velocity curve 402 shown on the right of the horizontal time axis corresponds to approximately 16:30 local time.

The time-series plot 400 of the sound velocity at 5 m depth below the waterline illustrates an overall trend of increasing sound velocity as the day progresses, and additionally exhibits an additional, more localized trend of the amount of variability in the samples obtained along each trackline also decreasing as the day progresses. For example, the time-series plot 400 illustrates 18 different clusters or spikes of data where the measured sound velocity varies between a local minimum and a local maximum. In particular, the time-series plot 400 illustrates respective sets of sound velocity measurement data 420-1, . . . , 420-3, . . . , 420-10, . . . , 420-18 that were samples at the nominal 5 m draft depth of the multibeam head along 18 different tracklines of the MBES sonar survey.

As noted above, a first trend corresponds to the increase in the average sound velocity measurement obtained during the 18 different tracklines. A second trend corresponds to the decrease in the variability of the individual sound velocity measurements sampled along a respective trackline, over time as the day progresses from morning to afternoon. For example, the first set of sound velocity measurements 420-1 sampled during the first trackline has a lower average sound velocity than the later sets of sound velocity measurements 420-10, 420-18, etc., obtained later in the day. Additionally, the first set of sound velocity measurements 420-1 exhibits a larger variability in the sampled values along the trackline, as compared to the decreased variability seen in the respective sample values along the later-measured tracklines corresponding to the sets of sound velocity measurements 420-109, 420-18, etc. For example, as illustrated in FIG. 4, the first set of sound velocity measurements 420-1 varies between a minimum of approximately 1,520 m/s sound speed and a maximum of approximately 1,521.25 m/s sound speed; by contrast, the later set of sound velocity measurements 420-10 has a decreased variability that ranges between a minimum of 1,521.5 m/s and a maximum of 1522 m/s. The still later set of sound velocity measurements 420-18 has a further decreased variability with the individual sound velocity samples confined within a range of less than 0.25 m/s difference between the local minimum and maximum value observed. Accordingly, the time-series plot 400 illustrates the changes in sound velocity profile corresponding to the water column both getting warmer (e.g., increase in average speed of sound measurement) and becoming more stratified (e.g., lesser variability in sampled values along the same trackline) as the day progresses and solar heating effects accumulate.

As noted previously, systems and techniques are described herein that can be used to adjust and/or optimize a sampling periodicity of an underway profiling device (e.g., such as a towed SVP, etc.) used to obtain sound velocity profile measurements during an acoustic survey, where the adjustment in sound velocity profile sampling periodicity is based on determining a local solar noon (LSN) time value corresponding to a main solar heating window of the surveyed water column. In one illustrative example, the LSN time value and/or the main solar heating window can correspond to the period of peak solar irradiance and/or solar heating of the surface layer(s) of the water column. For instance, the LSN time and the main solar heating window can correspond to the time period 350 of FIG. 3 which experiences the peak rate of change in the speed of sound in water.

Local solar noon, or LSN, can refer to the specific moment (e.g., time) during a solar day when the Sun crosses the local meridian of an observer's location and reaches its highest apparent position in the sky. At solar noon, the Sun is directly overhead at the local meridian, which is also seen to be the solar position resulting in the shortest (e.g., minimal) shadow cast by an object. The time of local solar noon need not be the same as noon according to the local time (e.g., local solar noon need not occur, and indeed typically does not occur, at exactly 12:00 local time). Local solar noon may also be referred to as local apparent noon or local celestial noon.

Local solar noon may also be referred to as “solar noon” for a particular location, as the timing of LSN is influenced by the observer's longitude and may further vary corresponding to the Earth's axial tilt and elliptical orbit. For example, “local” solar noon may refer to the fact that observers at different locations may each experience solar noon at different times on the same day, as well as the fact that an observer at the same location may experience solar noon at different times on different days/during different seasons.

For a given location, the LSN or solar noon occurs when the Sun is at its highest elevation or daily zenith, at a 180 degree azimuth (angular measurement from true north). The apparent motion of the Sun (e.g., the angular acceleration of the Sun) is minimized at and around the time of the LSN, and accordingly, the LSN or solar noon event for a given location can be seen to correspond to the time (e.g., within a given day) of peak solar heating and solar irradiance at the given location.

Notably, the dramatic change in the sound speed at the surface layer(s) of the water column, such as the peak rate of change corresponding to the period 350 shown in FIG. 3, can be seen to occur around the time of the local solar noon at the location where the sound speed measurements or sound velocity profiles are obtained. Local solar noon can be determined or otherwise calculated for a given latitude and longitude anywhere on the planet, with the stronger driving effect in variations in the local solar noon time corresponding to changes in longitude (e.g., east-west position on the globe) rather than changes in latitude (e.g., north-south position on the globe). The local solar noon calculation is also dependent on the calendar date, or more generally, the seasonality relating to variations in the Earth's elliptical orbit and the solar declination (e.g., position of the sun relative to the Earth).

In one illustrative example, solar noon can be defined (e.g., determined or otherwise calculated) for a given day and a particular longitude, as the time when the sun crosses the meridian of the observer's location. At the time of solar noon (e.g., local solar noon), a shadow cast by a vertical pole will be seen to point either directly north or directly south (depending on the observer's latitude and the time of year). Although the time of solar noon can be calculated for specific days, the day-to-day variability in the time of the solar noon can be relatively minor or even negligible. For example, the total variation in the time of local solar noon in many locations will vary by only approximately ±20 minutes over the course of a full calendar year. In some aspects, a local solar noon calculation can be performed based on inputs comprising or otherwise indicative of a specified latitude, longitude, and a time zone correction for the location corresponding to the specified latitude and longitude (e.g., an hours offset from UTC/Greenwich time). In some examples, the time of local solar noon at a given longitude varies by ±15 minutes from the median value over the full calendar year. For example, the earliest and latest times of the local solar noon in Houston, Texas may be 11:03:31 and 11:34:15 in local time, for a total variation of 30 minutes and 44 seconds.

Spatially, one degree of longitude corresponds to approximately four minutes of elapsed time delay or time difference in the local solar noon time. Accordingly, in at least some cases, approximately four degrees of change in longitude are needed for the time of local solar noon to vary by more than 15 minutes. As an illustrative example, in the southern United States, four degrees of longitude difference is approximately equal to the distance from Baton Rouge, Louisiana to Houston, Texas. In higher latitudes, London and Antwerp are another example of a city pair that are separated by approximately four degrees of longitude. In another illustrative example, an approximate difference of two degrees of longitude in the southern United States corresponds to the east-west straight line distance between Laredo, Texas and the Gulf of Mexico; while in higher latitudes, an example of two degrees of longitude approximately corresponds to the east-west straight line distance from Vienna, Austria to Budapest, Hungary. It is noted that the geographic or straight-line distance associated with a given longitude difference (e.g., such as four degrees, two degrees, one degree, etc.) varies with latitude. For instance, four degrees of longitude corresponds to a greater straight-line distance at latitudes near the Earth's equator, while the same four degrees of longitude also corresponds to a significantly shorter straight-line distance near the north or south pole of the Earth. More generally, it is noted that longitudinal differences can be seen to be latitude-dependent, which can be compensated or otherwise accounted for by the systems and techniques described herein when using a threshold longitude difference to trigger recalculation or updating of the LSN time.

As contemplated herein, the solar noon at a given location (e.g., the local solar noon for the given location) can be used to determine a main solar heating window (MSHW), or more generally, a period of time or time interval within the day where the influence of solar heating creates such rapid changes in the speed of sound and stratification in the upper water column that there exists a need to take additional water column profiles to measure the rapidly changing speed of sound in order to more accurately perform sound speed compensation during post-processing of MBES sonar or other acoustic survey data acquired at the same time.

For example, FIG. 5 is a graph 500 illustrating an example of a main solar heating window (MSHW) corresponding to local solar noon (LSN) time values during a period of time corresponding to acoustic survey operations performed within a water column, in accordance with some examples. In particular, the graph 500 of FIG. 5 illustrates a time-series chart of sound velocity measurements 502 in the upper water column, where the sound velocity measurements 502 span a two-day interval that includes a respective first and second LSN and MSHW for the first and second days.

For example, the graph 500 illustrates the time-series sound velocity measurements 502 overlaid with the local solar noon time LSN₁ 530-1 and corresponding main solar heating window MSHW₁ 550-1 determined for the first day, and further illustrates an overlay of the local solar noon time LSN₂ 530-2 and corresponding main solar heating window MSHW₂ determined for the second day. In one illustrative example, the MSHW 550-1, 550-2 for a given day can include the period of time corresponding to the maximum or peak rate of change in the measured speed of sound in the upper water column. For instance, MSHW 550-1 and 550-2 can each include the respective portion of the sound velocity measurements 502 that correspond to or are similar to the peak slope line 350 shown in FIG. 3.

Both LSN₁ 530-1 and LSN₂ 530₂ can represent respective times (e.g., in hours and minutes, or hours-minutes-seconds, etc.) as measured in the local time zone for the given location for which the solar noon has been determined. In one illustrative example, the local solar noon time value can be determined based on location information corresponding to a survey vessel or location information corresponding to a planned, configured, upcoming, etc., acoustic survey that is to be performed by the survey vessel (e.g., local solar noon time can be calculated for the survey vessel location, or for a point within the survey area associated with the survey vessel, or both).

In some cases, the local solar noon time may be calculated given an additional input comprising configured date information. For instance, the local solar noon time can be based on the location information of the survey vessel and/or the acoustic survey performed by the survey vessel, and further based on a configured date (e.g., recalling that local solar noon is specific to an observer's location and the calendar date of the observation). In some embodiments, the configured date used for the local solar noon determination may be the current date or a date when the location information was measured or determined. In some cases, the configured date is a date or date range for which the location information of the survey vessel and/or associated acoustic survey performed by the vessel is indicated as valid. For example, the solar noon time can be determined for a point in the future, based on location information indicative of location information of the survey vessel and/or acoustic survey that is scheduled for or otherwise anticipated on some future date. The future date(s) where this location information is valid may be the dates scheduled for performing the acoustic survey, and the same future date(s) may be provided as the configured date value used as an input to the determination of the local solar noon time.

In other examples, the local solar noon time used to configure, control, or otherwise adjust the sound velocity profile sampling periodicity during acoustic survey operations by the survey vessel can be determined without reference to the current date or exact date of the survey operations; instead, a seasonal approximate or seasonally correct date value can be used as a reference point for calculating the approximate local solar noon time during the acoustic surveying operations. For instance, in some examples, the local solar noon time can be determined or referenced to the local solar noon time at the specified location, on the date of an equinox for the current calendar year (e.g., the spring equinox or the fall equinox). Various other reference dates that are not equinoxes and/or that are not associated with celestial or astronomical events may also be used without departing from the scope of the disclosure. In some examples, the local solar noon time can be determined using the location information of the survey vessel or associated survey area, and a configured date comprising the closer one of either the spring equinox date or the fall equinox date.

In general, based on the relatively large temporal and spatial scales needed for the time of the LSN to vary by more than 15 minutes (e.g., as noted previously above), the LSN value(s) used by the systems and techniques described herein (e.g., such as the LSN 530-1, 530-2, etc., of FIG. 5) can be determined once per survey project and/or can be determined and/or re-determined a number of times that is less than the number of days of the survey project. In such examples, the same LSN time value may be re-used across multiple consecutive days of the survey project, again based on the relatively large temporal and spatial scales needed for the LSN to vary by more than a minute, 2 minutes, 3 minutes, 4 minutes, 15 minutes, etc.

An exception to the re-use of calculated LSN time values can be survey projects and survey operations relating to a survey of an east-west oriented underwater feature or object (e.g., east-west oriented cable, pipeline route, etc.), as the east-west orientation can correspond to the survey operations being performed along or substantially parallel to a line of latitude; in such cases, the movement of the survey vessel is almost entirely a movement in longitude, which is the primary influencing or driving factor in changes in the LSN time value. In such examples, the LSN time value(s) used by the systems and techniques described herein can be re-calculated or otherwise updated at a configured or periodic frequency, for example triggered based on or in response to a change in longitude during the course of the survey operations exceeding a configured threshold amount (e.g., such as a change in longitude of more than one degree, more than two degrees, more than three degrees, more than four degrees, etc.).

In some embodiments, a new or updated local solar noon determination or calculation can be performed in response to every four degrees of longitude change in the location information corresponding to the survey vessel and/or the acoustic survey operations that are performed by the survey vessel. In some aspects, an automated system can be implemented and configured to determine when the configured threshold of longitude change (e.g., four or more degrees of longitude change, etc.) has been met or exceeded, and to in response determine the updated LSN time and propagate the updated LSN time to corresponding updates in the main solar heating window time intervals. For instance, a change or update to one or more of the LSN times 530-=1, 530-2 of FIG. 5 can be automatically determined in response to a change in longitude above a threshold, and the changed or updated LSN 530-1, 530-2 can subsequently be used to propagate a corresponding change or update to the respective MSHW 550-1, 550-2 based on the updated LSN 530-1, 530-2, etc.

In some embodiments, the sampling periodicity for obtaining the sound speed measurements or sound velocity profiles by an underway profiler or towed SVP of the survey vessel performing the acoustic survey can be determined and/or adjusted based at least in part on the LSN time value 530-1, 530-2, etc., that is determined as described above. For example, the sampling periodicity for sound speed measurement or profiling can be adjusted based on a time value of LSN that is the same as or similar to the LSN time value 530-1 and/or 530-2, etc., of FIG. 5. In some examples, the LSN time value can be used to determine a time interval for increased sound velocity profiling (e.g., a time interval of a shorter sampling periodicity for obtaining the sound speed measurements or sound velocity profiles using the towed SVP 102 of FIG. 1 or other underway profiler device, etc.). For example, the LSN time value can be used to determine a time interval comprising a main solar heating window (MSHW) for the surveyed water column underneath the survey vessel. In some aspects, the time interval and/or MSHW can be the same as or similar to the MSHW 550-1 of FIG. 5 (determined based on the LSN 530-1 of FIG. 5), and/or can be the same as or similar to the MSHW 550-2 of FIG. 5 (determined based on the corresponding LSN 530-2 of FIG. 5), etc.

In one illustrative example, the MSHW 550-1, 550-2, etc., can comprise a time interval corresponding to increased upper water column heating from solar irradiance during or corresponding to the local solar noon. In particular, the MSHW can be a time interval that is determined using one or more configured offsets from the time value of solar noon. For instance, in some embodiments the MSHW may begin (e.g., have a start time) approximately one hour before the local solar noon time, and/or can continue for approximately two hours after the local solar noon time. In some aspects, MSHW 550-1 can have a starting time that is one hour before the LSN time 530-1 and can have an ending time that is two hours after the LSN time 530-1 (e.g., such that the ending time of MSHW 550-1 is three hours after the starting time). Similarly, MSHW 550-2 can have a starting time that is one hour before the LSN time 530-2 and can have an ending time that is two hours after the LSN time 530-2 (e.g., such that the ending time of MSHW 550-2 is three hours after the starting time).

In some examples, the MSHW time interval can be determined using one or more configured offsets from the local solar noon time associated with the same calendar day. The one or more configured offsets can be positive-valued time offsets applied relative to the time value of local solar noon, and/or can be negative-valued time offsets applied relative to the time value of local solar noon. In some examples, the size (e.g., value, length, duration, etc.) of the configured offsets from the LSN time can be determined based at least in part on a latitude corresponding to the location information, a longitude corresponding to the location information, a calendar date or day of the year, a season or seasonality information, water column depth or other depth information associated with the acoustic survey, etc.

For instance, in one illustrative example, and as depicted in FIG. 5, the time interval of the MSHW can be determined using a first offset (e.g., t₁) and a second offset (e.g., t₂) from the time value of solar noon, wherein the first offset and the second offset are included in the one or more configured offsets. In some aspects, the first offset t₁ is indicative of a difference between the time value of solar noon and a start of the MSHW time interval. For example, the first offset can be the same as or similar to the configured time offset t₁ shown in FIG. 5, where the time offset t₁ is used to determine the start time of MSHW₁ 550-1 (e.g., a start time of LSN₁-t₁). For instance, the first configured time offset t₁ can be equal to one hour/60 minutes, etc. The same configured time offset t₁ can also be used to determine the respective start time of the next day's MSHW₂ 550-2 (e.g., a start time of LSN₂-t₁).

In some examples, the second offset (e.g., t₂) can be indicative of a difference between an end of the MSHW time interval and the time value of solar noon. For example, the second offset can be the same as or similar to the configured time offset t₂ shown in FIG. 5 and used to determine the end time of MSHW₁ 550-1 (e.g., as LSN₁+t₂), and also used to determine the end time of the next day's MSHW₂ 550-2 (e.g., as LSN₂+t₂). In one illustrative example, the first configured time offset t₁ can be equal to one hour/60 minutes, and the second configured time offset t₂ can be equal to two hours/120 minutes, etc.

In some embodiments, the first configured offset value can be different from the second configured offset value. For example, the first configured offset value t₁ can be smaller than the second configured offset value t₂ (e.g., and the second configured offset value t₂ can be greater than the first configured offset value t₁). In some examples, the second configured offset is a multiple of the first configured offset. For instance, the second configured offset can be at least twice the first configured offset (e.g., t₂≥2*(t₁).

In some examples, a respective size for each of the one or more configured offsets from the LSN time value and used for determining the respective start and end times of each MSHW time interval can determined based on one or more of a latitude associated with the location information, a date or a season corresponding to the time value of solar noon, and/or depth information of the water column. In some aspects, the time interval extends from at least one hour before the time value of solar noon to at least two hours after the time value of solar noon. For example, the MSHW may open or start one hour before the LSN time, and the MSHW may close or end two hours after the LSN time, for an MSHW length or duration of approximately three hours. In such examples, the first configured offset t₁ can be equal to one hour (e.g., 60 minutes, etc.) and the second configured offset t₂ can be equal to two hours (e.g., 120 minutes, etc.). The first configured offset t₁ can also be set equal to time lengths that are greater than one hour, as well as lengths of less than one hour. Likewise, the second configured offset t₂ can also be set equal to lengths that are greater than two hours, as well as lengths of less than two hours.

The MSHW time interval (e.g., MSHW 550-1, 550-2, etc.) can be used to perform an acoustic survey using adjusted sampling periodicities of the sound velocity profile measurements. In particular, the sampling periodicity of the sound velocity profile measurements (e.g., the rate or frequency (in time) of sound profile casts/casting) can be adjusted according to whether the current time is within the MSHW or is outside of the MSHW for the current day. In some aspects, the systems and techniques described herein can be configured to control the manual, automated, and/or semi-automated operation and control of a winch system associated with deploying and retrieving the towed SVP 102 from the survey vessel 12 of FIG. 1, to thereby perform the sound velocity profile measurements using the appropriate sampling periodicity based on whether the current time is inside or outside of the calculated MSHW for the day. For example, the systems and techniques can be used to adjust or optimize a sampling periodicity for obtaining sound speed measurements (e.g., sound velocity profiles) by deploying the towed SVP 102 from the survey vessel 12 during acoustic survey operations using the MBES 150 mounted to the survey vessel 150.

In some aspects, the afternoon effect and increased or peak solar heating effect in the upper water column from solar irradiance during local solar noon and/or the MSHW can be used to adjust the water velocity profile sampling periodicity when the water depth (e.g., depth of the water column) is less than a configured threshold depth. In some embodiments, when the water column depth exceeds the configured threshold depth, the baseline sound velocity profile casting periodicity can be used (e.g., without the MSHW-specific adjustment described above), based on the solar heating effect and sound speed error associated with the MSHW being greatly reduced in deeper waters and deepwater open seas, where the ocean can absorb much more heat to a greater depth and thereby reduces the effect of the MSHW to a large extent.

In one illustrative example, the configured threshold depth can be equal to 20 meters, such that in water depths of approximately 20 m or less, additional sound velocity profile measurements are obtained (based on using a shorter cast periodicity) while a longer baseline cast periodicity is used to obtain the sound velocity profile measurements for times outside of the MSHW. In water depths greater than the approximately 20 m configured threshold value (and/or in deepwater open ocean environments, etc.), the baseline cast periodicity can be used to obtain all sound velocity profile measurements, with additional casts not being performed during the MSHW time interval.

In some embodiments, a survey vessel is configured to perform the acoustic survey to thereby obtain a plurality of sonar measurements and a plurality of sound velocity profile measurements within a water column. Based on the LSN 530-1, 530-2, the MSHW time interval start and end times are determined for the first and second surveying days represented in FIG. 5. The subset of sound velocity profile measurements that are obtained outside of the time interval corresponding to either the MSHW 550-1 or the MSHW 550-2 can be obtained using a first sampling periodicity (e.g., first cast frequency), which in one illustrative example can be equal to a baseline periodicity of obtaining a sound velocity profile measurement once every 30 minutes (e.g., two profiles per hour).

The subset of sound velocity profile measurements that are obtained inside of (e.g., within) one of the MSHW time intervals 550-1, 550-2 can be obtained using a second sampling periodicity that is shorter than the first/baseline sampling periodicity (e.g., using a second cast frequency that is greater than the first/baseline cast frequency). For example, the baseline sampling periodicity can be 30 minutes, corresponding to two sound velocity profile measurements every hour when outside of the MSHW; the second sampling periodicity can be 15 minutes, corresponding to four sound velocity profile measurements every hour while within the MSHW time interval.

Various other sampling periodicities and relationships or multipliers between the first, baseline value and the second, increased value during the MSHW can also be utilized without departing from the scope of the disclosure. In general, it is contemplated that the second sampling periodicity used within the MSHW (and in shallow water conditions where the afternoon heating effect associated with the MSHW and LSN dominates or otherwise creates significant transient thermoclines that can cause sound speed errors in the MBES or other acoustic/sonar data obtained during the survey) is shorter than the first sampling periodicity.

In some cases, performing the acoustic survey includes increasing, in response to a start of the MSHW time interval, a quantity of sound velocity profile measurements obtained per hour from a first number (e.g. two) to a second number (e.g., four). In some cases, performing the acoustic survey includes decreasing, in response to an end of the MSHW time interval, the quantity of sound velocity profile measurements obtained per hour from the second number (e.g., four) to the first number (e.g., two). For example, the first number can correspond to the first sampling periodicity (e.g., every 30 minutes), and the second number can correspond to the second sampling periodicity (e.g., every 15 minutes). In some aspects, the second sampling periodicity is less than or equal to half of the first sampling periodicity. In some cases, the second sampling periodicity is less than or equal to 80% of the first sampling periodicity, 60% of the first sampling periodicity, 50% of the first sampling periodicity, 40% of the first sampling periodicity, 30% of the first sampling periodicity, 25% of the first sampling periodicity, etc.

In some examples, the plurality of sonar measurements can be obtained using a first survey vessel (e.g., a survey vessel including the MBES 150 of FIG. 1, etc.), and the plurality of sound velocity profile measurements can be obtained using a second survey vessel (e.g., a survey vessel including the towed SVP 102 of FIG. 1 or other underway profiling device, etc.), where the second survey vessel is different from the first survey vessel. For instance, the first and second survey vessels can perform a cooperative, collaborative, distributed, etc., acoustic survey of a configured area of water column, based on a relatively close proximity between the first and second survey vessel (e.g., a separation distance between the first and second survey vessels being within a configured threshold distance, etc.).

In some cases, the plurality of sonar measurements are obtained using one or more sonar transceivers coupled to a hull of the survey vessel and positioned within the water column, and the plurality of sound velocity profile measurements are obtained using an underway profiler deployed from the survey vessel into the water column, wherein the underway profiler is deployed corresponding to the first sampling periodicity outside of the time interval and is deployed corresponding to the second sampling periodicity within the time interval. In some cases, the sound velocity profile measurements are obtained using an underway profiler deployed from a deck of the survey vessel and into the water column, for example via a winch or winch-based system, etc. In some cases, the sound velocity profile measurements may be obtained using an underway profiler deployed from a side of the hull of the survey vessel, deployed via a rotatable pole or shaft rotatably coupled to a side of the hull of the survey vessel, and/or deployed from a moonpool of the survey vessel, etc.

In some embodiments, the updated location information associated with one or more of the survey vessel or the acoustic survey can trigger and/or can be used to determine an updated time value of solar noon based on the updated location information. Subsequently, the updated LSN time value can be used for updating the MSHW time interval starting time and/or ending time based on the updated time value of solar noon. In one illustrative example, the updated time value of solar noon can be determined in response to a difference between the updated location information and the location information being greater than or equal to two degrees of longitude. In some aspects, the updated time value of solar noon can be determined in response to a difference between the updated location information and the location information being greater than or equal to one degree of longitude. In some examples, the updated time value of solar noon can be determined in response to a difference between the updated location information and the location information being greater than or equal to three degrees of longitude. In another example, the updated time value of solar noon can be determined in response to a difference between the updated location information and the location information being greater than or equal to four degrees of longitude.

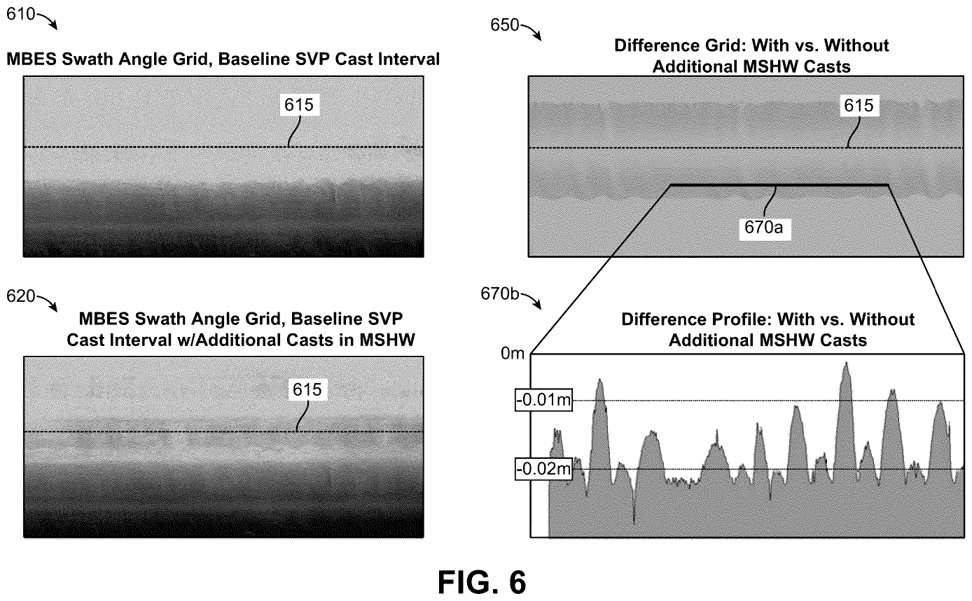

FIG. 6 is a diagram illustrating example graphs of an MBES swath angle grid with and without performing additional sound velocity profile casts (e.g., measurements) during the MSHW corresponding to the local solar noon time value, and further illustrating difference graphs determined therebetween, in accordance with some examples. In particular, FIG. 6 includes a graph 610 of an MBES swath angle grid obtained from MBES sonar measurements obtained for a given survey area, where the MBES sonar measurements are post-processed (e.g., sound speed corrected) using sound velocity profile measurements that were obtained at a baseline SVP cast interval (e.g., such as one profile measurement every 30 minutes, as discussed in the examples above).

FIG. 6 further includes a graph 620 of an MBES swath angle grid obtained from the same MBES sonar measurements of the same given survey area, but with post processing of the same MBES sonar data instead being performed using sound velocity profile measurements that were obtained at a shorter, increased SVP cast interval. In particular, the increased SVP casts associated with the graph 620 can comprise the sound velocity profile measurements obtained at the baseline SVP cast interval, plus one or more additional sound velocity profile measurements obtained at the increased SVP cast interval during the MSHW, as has been described previously above with respect to FIG. 5.

In other words, the graph 610 illustrates the MBES sonar data with sound speed correction and/or other post-processing performed using only baseline SVP measurements over the entire period of sonar data acquisition (e.g., a baseline periodicity of 30 minutes per/between successive casts); by contrast, the graph 620 illustrates the same MBES sonar data with an improved sound speed correction and/or other post-processing performed based on additional SVP measurements at a shorter periodicity within each MSHW during the period of sonar data acquisition (e.g., the same baseline of 30 minutes between casts when outside of the MSHW, and the shorter periodicity of 15 minutes between casts when within each MSHW during the period of sonar data acquisition).

For example, both graph 610 and graph 620 include a survey trackline 615 that was obtained during (e.g., within) the main solar heating window (MSHW). The processed depth grid depicted in graph 610 is obtained as the result without using the presently disclosed additional casts during the MSHW; graph 620 is the same data when processed into a depth grid using the additional casts acquired during the MSHW. The underlying MBES sonar data associated with generating the processed depth grids of both graphs 610 and 620 corresponds to a water depth of less than 10 meters during this part of the survey

The graph 650 is a difference grid of the same MBES sonar dataset, and more particularly, illustrates a difference grid between the processed depth grid results 610 that were obtained with only the baseline SVP sampling periodicity, versus the processed depth grid results 620 that were obtained using the additional casts at the shorter SVP sampling periodicity within the MSHW. The same survey trackline 615 is also overlaid on the difference grid 650.

The line 670a within the difference grid 650 is a profile line representing the portion of the difference grid data that is represented in the difference profile graph 670b. In other words, the difference profile graph 670b is a profile view of the profile line 670a shown in the difference grid 650. Notably, the difference profile graph 670b illustrates that the difference in the refraction error between the baseline processed depth grid 610 (using SVP casts every 30 minutes) and the improved processed depth grid 620 (using SVP casts every 15 minutes during the MSHW) is equal to approximately 2 centimeters (cm) or more over the length of the profile line 670a.

A refraction error of 2 centimeters is equal to approximately 10% of the total allowable vertical error of an IHO S-44 Special Order Survey, and represents a significant error that it would be desirable to reduce, minimize, and/or eliminate entirely. Advantageously, the systems and techniques described herein can be seen to achieve at least this 10% reduction in refraction error/total vertical error, based on obtaining the additional sound velocity profile measurements by performing additional casts, beyond the baseline casts, at the increased sampling periodicity during the MSHW time interval.

For the example where the MSHW is three hours in length (e.g., 1 hr before the LSN time until 2 hours after the LSN time), and given a baseline sampling periodicity of 30 mins and an MSHW sampling periodicity of 15 mins, the improvement in the final processed depth grid 620 and the reduction in the refraction/total depth error seen in graphs 650 and 670b is achieved using only six extra sound velocity profile casts per day—corresponding to 2 additional casts for each hour of the 3 hr MSHW. By increasing the sound velocity cast rate during the MSHW, additional sound velocity profile information is obtained during the time(s) when sound velocity in the water column is exhibiting its most rapid and significant change.

By maintaining the baseline cast rate outside of the MSHW, the total number of casts per day is minimized, which can be desirable to minimize the health, safety, security and environment (HSSE) exposure of the crew members operating/deploying the underway SVP profiler from the survey vessel in order to perform each SVP measurement during the acoustic survey. For example, increasing the total number of SVP casts performed for a given period of time (such as a day) increases the HSSE risk. For at least this reason, the approach of continuously casting at the increased rate of one SVP measurement every 15 minutes or less is undesirable and often times, unfeasible, due to the creation of an unacceptable increase in the HSSE risk and/or HSSE burden (e.g., generally referred to as HSSE problems or challenges).

In some aspects, the increased MSHW cast rate corresponding to four sound velocity profile measurements per hour within the MSHW (e.g., corresponding to the shorter sampling periodicity of once per 15 minutes) is selected based on providing an optimal balance between the benefit obtained from additional SVP measurements to improve the sound speed error correction post-processing of the MBES sonar/acoustic data, versus the increased HSSE exposure and risk of loss that accumulates with every additional deployment of the towed SVP apparatus or other underway profiler device. For example, in some cases, diminishing benefits or returns are observed in pursuing 1-2 extra minutes of variation, or performing 5 casts per hour during the MSHW instead of 4 casts per hour as described above, where the diminishing benefits or returns no longer outweigh the corresponding additional HSSE risk and HSSE exposure that is accumulated.

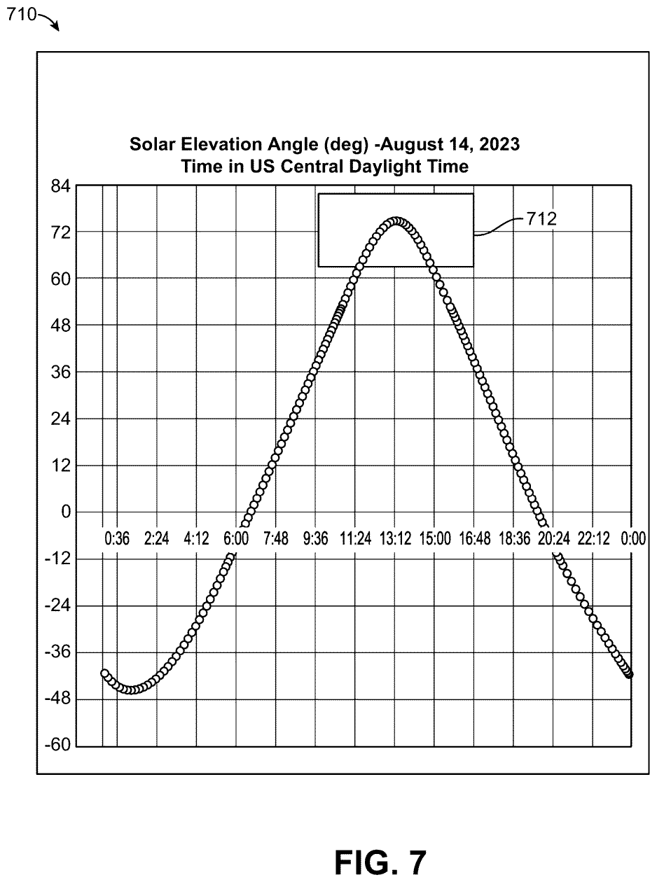

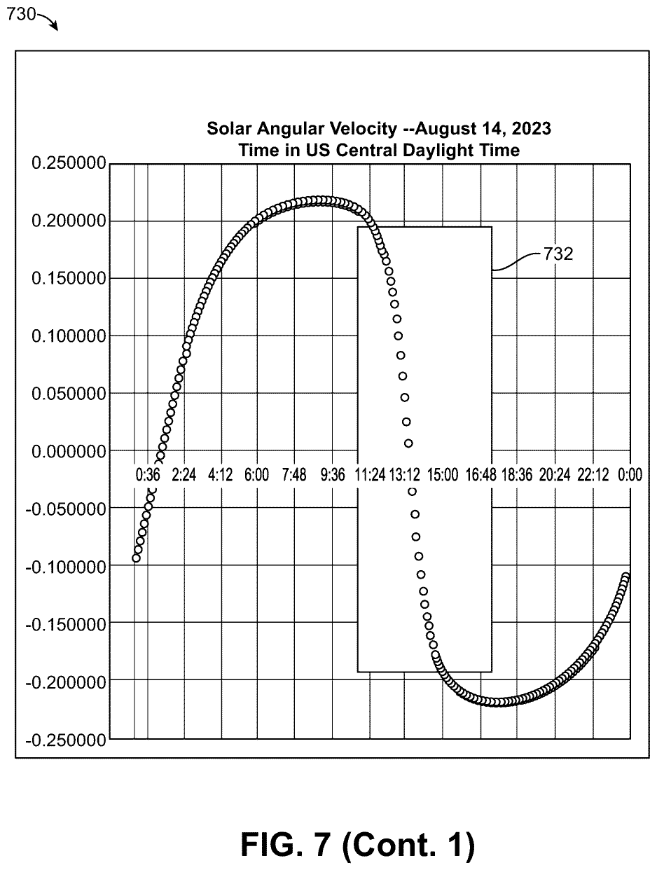

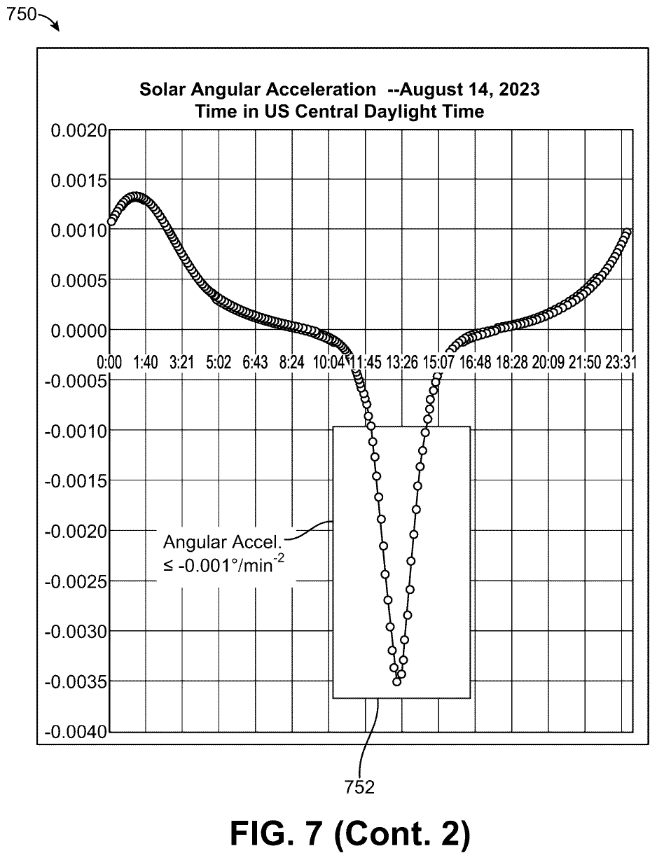

FIG. 7 is a diagram illustrating example graphs of solar elevation angle (e.g., graph 710), solar angular velocity (e.g., graph 730), and solar angular acceleration (e.g., graph 750), each associated with a threshold corresponding to a peak solar heating effect within the MSHW, in accordance with some examples. In some aspects, the effect of the solar heating window described herein (e.g., MSHW) may be greatest when the angular acceleration of the Sun is smaller than (e.g., less than, below, etc.) a threshold value on the solar angular acceleration.

For example, the solar elevation angle graph 710 includes a region 712 corresponding the MSHW, based on the region 712 comprising the time interval of maximum/peak solar elevation during a given day. The solar angular velocity graph 730 can be obtained as the first derivative, with respect to time, of the solar elevation angle graph 710. The region 732 of the solar angular velocity graph 730 corresponds to the region 712 of peak elevation angle shown in the solar elevation angle graph 710.

The solar angular acceleration graph 750 can be obtained as the first derivative, with respect to time, of the solar angular velocity graph 730—which is the same as the second derivative, with respect to time, of the solar elevation angle graph 710. The region 752 of the solar angular acceleration graph 750 corresponds to the region 732 of the solar angular velocity graph 732, and therefore also corresponds to the region 712 of peak elevation angle in the solar elevation angle graph 710.

In one illustrative example, the region 752 of the solar angular acceleration graph 750 corresponds to the time interval of the MSHW, and includes the time periods of the greatest increase (change in slope of the sound speed curve) in speed of sound in the water column, as can be consistently observed during the period of 1 hour before to 2 hours after local solar noon within relatively shallow water columns with depths less than approximately 20 m, 25 m, 30 m, etc.

In particular, the region 752 of the solar angular acceleration graph 750 corresponds to the time interval during the given day wherein the angular acceleration of the sun is less than a threshold value of −0.001°/min². In one illustrative example, the region 752 of the solar angular acceleration graph 750 can be the same as or similar to the MSHW. For instance, the region 752 of solar angular acceleration less than the threshold value of −0.001°/min² can be the same as the MSHW. In some embodiments, the region 752 of solar angular acceleration less than the threshold value of −0.001°/min² can be included within the MSHW, where the MSHW starts earlier than the start time of the region 752, ends later than the end time of the region 752, or both. In some examples, the MSHW includes at least a portion of the region 752 of solar angular acceleration less than the threshold value of −0.001°/min², without the MSHW include the entirety of the region 752. As noted previously, the Main Solar Heating Window (MSHW) described herein can refer to the specific time period during a day when the solar irradiance is at its peak, resulting in the maximum potential for solar energy absorption and heating. This window typically occurs around Local Solar Noon (LSN) when the Sun is at its highest point in the sky, and the angle of solar incidence is most direct. The solar angular acceleration being less than the threshold value of −0.001°/min² can correspond to periods such as summer afternoons when the Sun appears to hang overhead with minimal movement, and therefore peak solar irradiation and solar heating of the objects below.

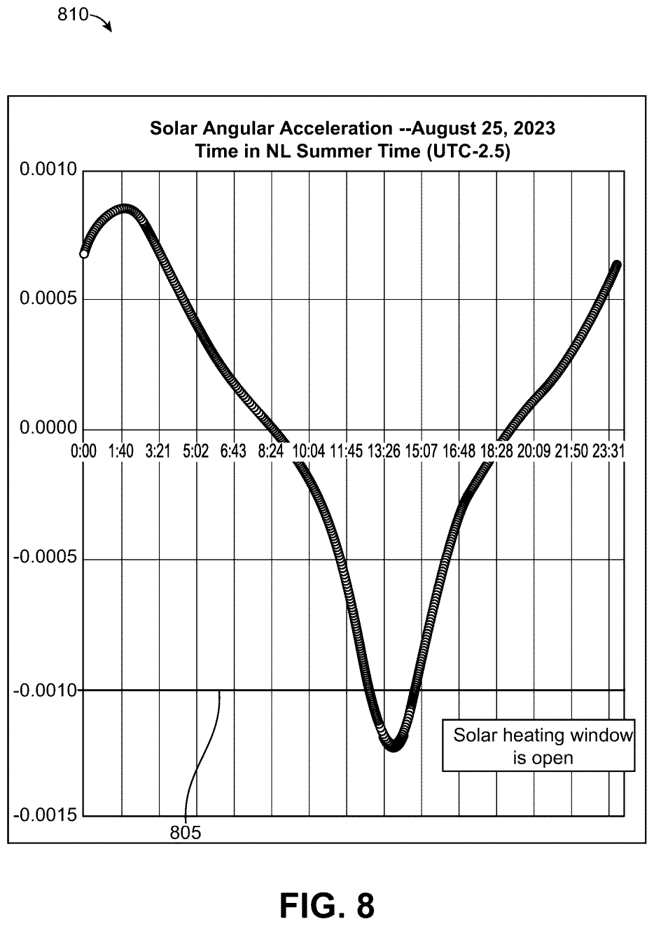

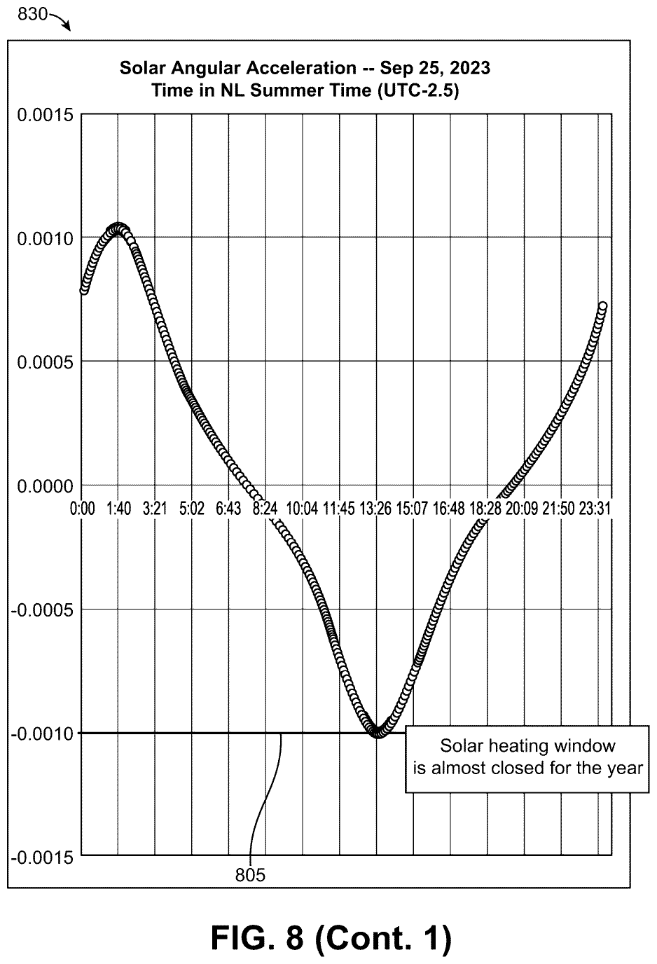

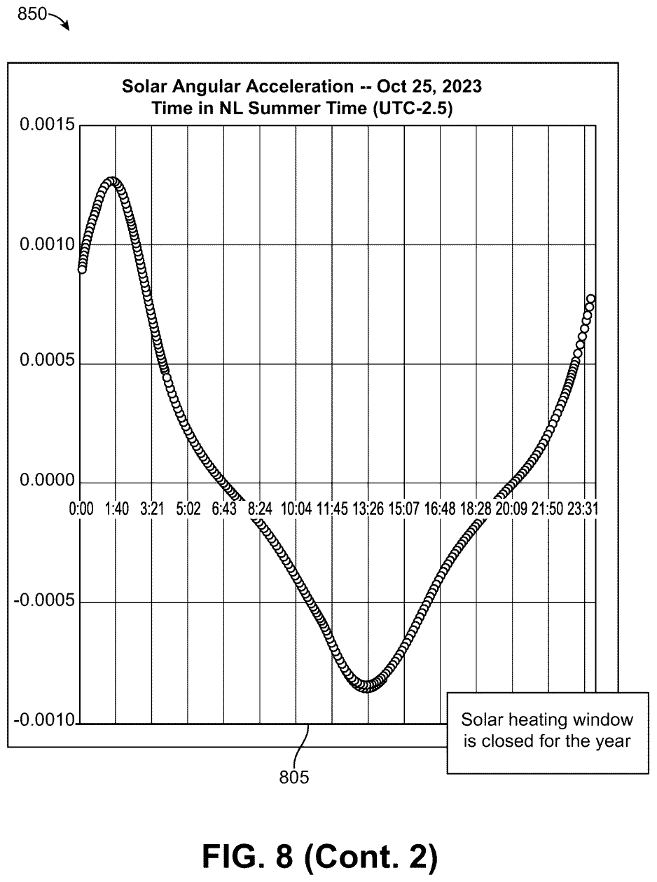

FIG. 8 is a diagram illustrating example graphs depicting seasonality-based changes in a solar heating window (e.g., the MSHW) for a body of water or water column, in accordance with some examples. The graphs 810, 830, and 850 each depict solar angular acceleration for a given location on different calendar days within a year. In some aspects, the solar angular acceleration graphs 810, 830, and 850 may be the same as or similar to the solar angular acceleration graph 750 described above with respect to FIG. 7.

In some aspects, the first solar angular acceleration graph 810 corresponds to a calendar date that is during the summer, prior to the autumnal equinox (e.g., such as August 25^{th}). The second solar angular acceleration graph 830 corresponds to a calendar date that is one month later than the date associated with the first solar angular acceleration graph 810. For instance, the second solar angular acceleration graph 830 can correspond to a calendar date in the fall, after the autumnal equinox (e.g., such as September 25^{th}). The third solar angular acceleration graph 850 corresponds to a calendar date that is one additional month later than the date associated with the second solar angular acceleration graph 830 (e.g., such as October 25^{th}).

The three solar angular acceleration graphs 810, 830, 850 are each overlaid with a threshold line 805, which indicates a configured threshold value on the solar angular acceleration corresponding to the MSHW. For example, the configured threshold line 805 can correspond to and/or be the same as the threshold value of −0.001°/min² described above with respect to the examples of FIG. 7. The threshold line 805 can be determined based on project-specific requirements and is used as an indication of the degree to which the MSHW is relevant to the expected change rate of the water column sound velocity. In one illustrative example, the seasonality of the MSHW is illustrated by the relative position of the solar angular acceleration curves of graphs 810, 830, and 850 relative to the static value of the threshold line 805. In some embodiments, the time interval, length, and/or duration of the MSHW can be defined as the period of time during which the solar angular acceleration is less than or equal to the configured threshold value associated with the threshold line 805. Accordingly, FIG. 8 represents the MSHW on different days of the year, where the MSHW occurs between the times where the solar angular acceleration curve first intersects/cross below the threshold line 805 at the threshold value of −0.001°/min² solar angular acceleration.

For instance, the seasonality of the MSHW can include the duration of the MSHW, which can decrease from the summer and into the fall and beyond. In the example of the first graph 810, the solar heating window of the MSHW remains open for the year, as a portion of the solar angular acceleration curve in graph 810 passes below the threshold line 805. One month later, in the example of the second graph 830, the solar heating window of the MSHW has almost closed for the year, as the portion of the solar angular acceleration curve in graph 830 passes only slightly below the threshold line 805 (e.g., the solar angular acceleration curve 830 either has only a single intersection point with the threshold line 805, or has first and second intersection points that occur with a minor or negligible time separation therebetween, i.e. the angular acceleration curve passes below the threshold line 805 and almost immediately returns back upwards to above the threshold line 805, etc.). One further month later, in the example of the third graph 850, the solar heating window of the MSHW has closed entirely for the year, based on the solar angular acceleration curve 850 never passing below or intersecting with the threshold line 805—when the MSHW is closed for the year, seasonality effects result in solar irradiance falling and/or solar heating effects falling below the threshold needed to cause significant transient thermoclines within the upper water column to an extent that would trigger the performance of additional sound velocity profile casts to measure rapidly changing sound speed in the water column due to solar heating.

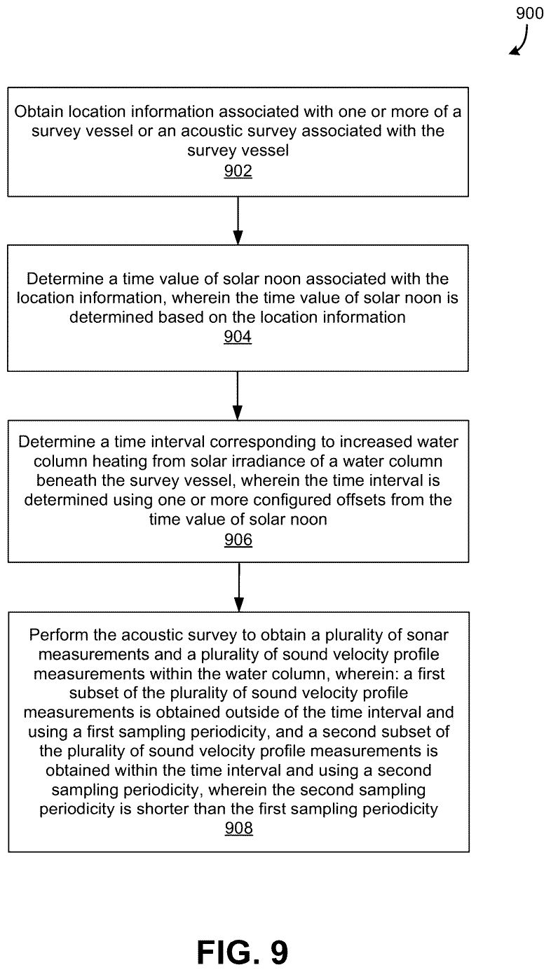

FIG. 9 is a flowchart diagram illustrating an example of a process 900 for performing an acoustic survey using a sampling periodicity of sound velocity profile measurements adjusted according to a time interval determined based on the local solar noon time value, in accordance with some examples. For example, the process 900 can correspond to acoustic surveys and/or acoustic surveying operations performed by a survey vessel that includes an acoustic sensor or sonar and an underway profiler device, such as the survey vessel 12 of FIG. 1 which includes an MBES 150 and a towed SVP 102 (e.g., an example of an underway profiler device). In some aspects, the process 900 can be performed to control the manual, automated, and/or semi-automated operation and control of a winch system associated with deploying and retrieving the towed SVP 102 from the survey vessel 12. For example, the process 900 can be used to adjust or optimize a sampling periodicity for obtaining sound speed measurements (e.g., sound velocity profiles) by deploying the towed SVP 102 from the survey vessel 12 during acoustic survey operations using the MBES 150 mounted to the survey vessel 150.

In some aspects, the sampling periodicity for obtaining the sound speed measurements or sound velocity profiles can be determined and/or adjusted based at least in part on a local solar noon (LSN) time value determined based on location information of the survey vessel and/or of the acoustic survey. For example, the sampling periodicity for sound speed measurement or profiling can be adjusted based on a time value of LSN that is the same as or similar to the LSN time value 530-1 of FIG. 5 and/or the LSN time value 530-2, etc., of FIG. 5. In some examples, the LSN time value can be used to determine a time interval for increased sound velocity profiling (e.g., a time interval of a shorter sampling periodicity for obtaining the sound speed measurements or sound velocity profiles using the towed SVP 102 of FIG. 1 or other underway profiler device, etc.). For example, the LSN time value can be used to determine a time interval comprising a main solar heating window (MSHW) for the surveyed water column underneath the survey vessel. In some aspects, the time interval and/or MSHW can be the same as or similar to the MSHW 550-1 of FIG. 5 (determined based on the LSN 530-1 of FIG. 5), and/or can be the same as or similar to the MSHW 550-2 of FIG. 5 (determined based on the corresponding LSN 530-2 of FIG. 5), etc.

In some aspects, at block 902, the process 900 can include obtaining location information associated with one or more of a survey vessel or an acoustic survey associated with the survey vessel. At block 904, the process 900 can include determining a time value of solar noon associated with the location information, wherein the time value of solar noon is determined based on the location information. At block 906, the process 900 can include determining a time interval corresponding to increased water column heating from solar irradiance of a water column beneath the survey vessel, wherein the time interval is determined using one or more configured offsets from the time value of solar noon. In some examples, the one or more configured offsets can be positive-valued time offsets applied relative to the time value of local solar noon, and/or can be negative-valued time offsets applied relative to the time value of local solar noon. In some examples, the size (e.g., value, length, duration, etc.) of the configured offsets from the LSN time can be determined based at least in part on a latitude corresponding to the location information, a longitude corresponding to the location information, a calendar date or day of the year, a season or seasonality information, water column depth or other depth information associated with the acoustic survey, etc.

In one illustrative example, the time interval comprises the MSHW determined corresponding to a local solar noon time value for the location of the survey vessel or a location of the acoustic survey operations (e.g., a point or location within an area of the acoustic survey operations, etc.). For example, the time interval can comprise a MSHW such as the MSHW 550-1 of FIG. 5, which is determined based on applying configured offsets to the LSN 530-1 of FIG. 5, and/or can be the same as or similar to the MSHW 550-2 of FIG. 5, which is determined based on applying the configured offsets to the corresponding LSN time 530-2 of FIG. 5, etc.

In some embodiments, the time interval is determined using a first offset and a second offset from the time value of solar noon, wherein the first offset and the second offset are included in the one or more configured offsets. In some aspects, the first offset is indicative of a difference between the time value of solar noon and a start of the time interval. For example, the first offset can be the same as or similar to the configured time offset t₁ shown in FIG. 5 and used to determine the start time of MSHW 550-1 as LSN₁-t₁, and also used to determine the start time of the next day's MSHW 550-2 as LSN₂-t₁.

In some examples, the second offset is indicative of a difference between an end of the time interval and the time value of solar noon. For example, the second offset can be the same as or similar to the configured time offset t₂ shown in FIG. 5 and used to determine the end time of MSHW 550-1 (e.g., as LSN₁+t₂), and also used to determine the end time of the next day's MSHW 550-2 (e.g., as LSN₂+t₂). In some embodiments, the first configured offset value can be different from the second configured offset value. For example, the first configured offset value t₁ can be smaller than the second configured offset value t₂ (e.g., and the second configured offset value t₂ can be greater than the first configured offset value t₁). In some examples, the second configured offset is a multiple of the first configured offset. For instance, the second configured offset can be at least twice the first configured offset (e.g., t₂≥2*t₁).

In some examples, a respective size for each of the one or more configured offsets can determined based on one or more of a latitude associated with the location information, a date or a season corresponding to the time value of solar noon, and/or depth information of the water column. In some aspects, the time interval extends from at least one hour before the time value of solar noon to at least two hours after the time value of solar noon. For example, the MSHW may open or start one hour before the LSN time, and the MSHW may close or end two hours after the LSN time, for an MSHW length or duration of approximately three hours. In such examples, the first configured offset t₁ can be equal to one hour (e.g., 60 minutes, etc.) and the second configured offset t₂ can be equal to two hours (e.g., 120 minutes, etc.).

The first configured offset t₁ can also be set equal to lengths that are greater than one hour, as well as lengths of less than one hour. Likewise, the second configured offset t₂can also be set equal to lengths that are greater than two hours, as well as lengths of less than two hours.

At block 908, the process 900 can include performing the acoustic survey to obtain a plurality of sonar measurements and a plurality of sound velocity profile measurements within the water column. In some examples, a first subset of the plurality of sound velocity profile measurements is obtained outside of the time interval and using a first sampling periodicity. A second subset of the plurality of sound velocity profile measurements is obtained within the time interval and using a second sampling periodicity, wherein the second sampling periodicity is shorter than the first sampling periodicity. In some cases, performing the acoustic survey includes increasing, in response to a start of the time interval, a quantity of sound velocity profile measurements obtained per hour from a first number to a second number. In some cases, performing the acoustic survey includes decreasing, in response to an end of the time interval, the quantity of sound velocity profile measurements obtained per hour from the second number to the first number. For example, the first number can correspond to the first sampling periodicity, and the second number can correspond to the second sampling periodicity.

In some aspects, the second sampling periodicity is less than or equal to half of the first sampling periodicity. In some cases, the second sampling periodicity is less than or equal to 80% of the first sampling periodicity, 60% of the first sampling periodicity, 50% of the first sampling periodicity, 40% of the first sampling periodicity, 30% of the first sampling periodicity, 25% of the first sampling periodicity, etc.

In some examples, the plurality of sonar measurements can be obtained using a first survey vessel (e.g., a survey vessel including the MBES 150 of FIG. 1, etc.), and the plurality of sound velocity profile measurements can be obtained using a second survey vessel (e.g., a survey vessel including the towed SVP 102 of FIG. 1 or other underway profiling device, etc.), where the second survey vessel is different from the first survey vessel. For instance, the first and second survey vessels can perform a cooperative, collaborative, distributed, etc., acoustic survey of a configured area of water column, based on a relatively close proximity between the first and second survey vessel (e.g., a separation distance between the first and second survey vessels being within a configured threshold distance, etc.).

In some cases, the plurality of sonar measurements are obtained using one or more sonar transceivers coupled to a hull of the survey vessel and positioned within the water column, and the plurality of sound velocity profile measurements are obtained using an underway profiler deployed from the survey vessel into the water column, wherein the underway profiler is deployed corresponding to the first sampling periodicity outside of the time interval and is deployed corresponding to the second sampling periodicity within the time interval. In some cases, the sound velocity profile measurements are obtained using an underway profiler deployed from a deck of the survey vessel and into the water column, for example via a winch or winch-based system, etc. In some cases, the sound velocity profile measurements may be obtained using an underway profiler deployed from a side of the hull of the survey vessel, deployed via a rotatable pole or shaft rotatably coupled to a side of the hull of the survey vessel, and/or deployed from a moonpool of the survey vessel, etc.

In some embodiments, the process 900 can further include determining updated location information associated with one or more of the survey vessel or the acoustic survey, and determining an updated time value of solar noon based on the updated location information. The process 900 can further include updating the time interval (e.g., the MSHW) using the updated time value of solar noon.

In one illustrative example, the updated time value of solar noon can be determined in response to a difference between the updated location information and the location information being greater than or equal to two degrees of longitude. In some aspects, the updated time value of solar noon can be determined in response to a difference between the updated location information and the location information being greater than or equal to one degree of longitude. In some examples, the updated time value of solar noon can be determined in response to a difference between the updated location information and the location information being greater than or equal to three degrees of longitude. In another example, the updated time value of solar noon can be determined in response to a difference between the updated location information and the location information being greater than or equal to four degrees of longitude.

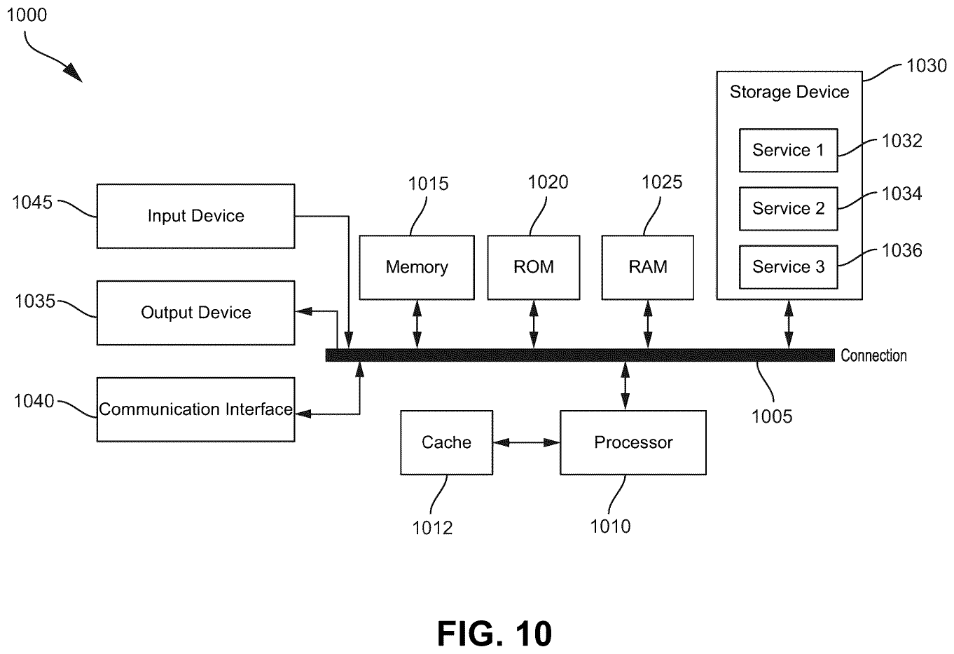

FIG. 10 is a diagram illustrating an example of a system for implementing certain aspects of the present technology. In particular, FIG. 10 illustrates an example of computing system 1000, which may be for example any computing device making up internal computing system, a remote computing system, a camera, or any component thereof in which the components of the system are in communication with each other using connection 1005. Connection 1005 may be a physical connection using a bus, or a direct connection into processor 1010, such as in a chipset architecture. Connection 1005 may also be a virtual connection, networked connection, or logical connection.

In some aspects, computing system 1000 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 1000 includes at least one processing unit (CPU or processor) 1010 and connection 1005 that communicatively couples various system components including system memory 1015, such as read-only memory (ROM) 1020 and random access memory (RAM) 1025 to processor 1010. Computing system 1000 may include a cache 1012 of high-speed memory connected directly with, in close proximity to, or integrated as part of processor 1010.

Processor 1010 may include any general-purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which may represent any number of input mechanisms, such as a microphone for speech, a touch-sensitive screen for gesture or graphical input, keyboard, mouse, motion input, speech, etc. Computing system 1000 may also include output device 1035, which may be one or more of a number of output mechanisms. In some instances, multimodal systems may enable a user to provide multiple types of input/output to communicate with computing system 1000.

Computing system 1000 may include communications interface 1040, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1030 may include software services, servers, services, etc., that when the code that defines such software is executed by the processor 1010, it causes the system to perform a function. In some aspects, a hardware service that performs a particular function may include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

1. A method comprising:
obtaining location information associated with one or more of a survey vessel or an acoustic survey associated with the survey vessel;
determining a time value of solar noon associated with the location information, wherein the time value of solar noon is determined based on the location information;
determining a time interval corresponding to increased water column heating from solar irradiance of a water column beneath the survey vessel, wherein the time interval is determined using one or more configured offsets from the time value of solar noon; and
performing the acoustic survey to obtain a plurality of sonar measurements and a plurality of sound velocity profile measurements within the water column, wherein:
a first subset of the plurality of sound velocity profile measurements is obtained outside of the time interval and using a first sampling periodicity; and
a second subset of the plurality of sound velocity profile measurements is obtained within the time interval and using a second sampling periodicity, wherein the second sampling periodicity is shorter than the first sampling periodicity.

2. The method of claim 1, further comprising:
determining updated location information associated with one or more of the survey vessel or the acoustic survey;
determining an updated time value of solar noon based on the updated location information; and
updating the time interval using the updated time value of solar noon.

3. The method of claim 2, wherein the updated time value of solar noon is determined in response to a difference between the updated location information and the location information being greater than or equal to two degrees of longitude.

4. The method of claim 1, wherein the second sampling periodicity is less than or equal to half of the first sampling periodicity.

5. The method of claim 1, wherein performing the acoustic survey includes:
increasing, in response to a start of the time interval, a quantity of sound velocity profile measurements obtained per hour from a first number to a second number; and
decreasing, in response to an end of the time interval, the quantity of sound velocity profile measurements obtained per hour from the second number to the first number,
wherein the first number corresponds to the first sampling periodicity, and wherein the second number corresponds to the second sampling periodicity.

6. The method of claim 1, wherein:
the plurality of sonar measurements are obtained using one or more sonar transceivers coupled to a hull of the survey vessel and positioned within the water column; and
the plurality of sound velocity profile measurements are obtained using an underway profiler deployed from the survey vessel into the water column, wherein the underway profiler is deployed corresponding to the first sampling periodicity outside of the time interval and is deployed corresponding to the second sampling periodicity within the time interval.

7. The method of claim 6, wherein:
the one or more sonar transceivers comprise one or more multibeam echosounder (MBES) transducer arrays; and
the underway profiler comprises an underway sound velocity profiler (SVP), preferably a towed SVP.

8. The method of claim 1, wherein the location information is indicative of at least a longitude of a geographic location corresponding to one or more of the survey vessel or the acoustic survey, and wherein the time value of solar noon corresponds to the longitude.

9. The method of claim 8, wherein the time value of solar noon further corresponds to one or more of a latitude of the geographic location or a configured date value, wherein the configured date value comprises: an acquisition date associated with the location information, a future date associated with the acoustic survey, or a pre-determined date.

10. The method of claim 1, wherein:
the time interval is determined using a first offset and a second offset from the time value of solar noon, the first offset and the second offset included in the one or more configured offsets;
the first offset is indicative of a difference between the time value of solar noon and a start of the time interval; and
the second offset is indicative of a difference between an end of the time interval and the time value of solar noon.

11. The method of claim 10, wherein the second offset is greater than the first offset.

12. The method of claim 1, wherein a respective size for each of the one or more configured offsets is determined based on one or more of: a latitude associated with the location information, a date or a season corresponding to the time value of solar noon, or depth information of the water column.

13. The method of claim 1, wherein the time interval extends from at least one hour before the time value of solar noon to at least two hours after the time value of solar noon.

14. The method of claim 1, wherein the time interval comprises a particular portion of a day corresponding to a main solar heating window (MSHW) for the water column beneath the survey vessel, and wherein the MSHW is based on one or more of:
a peak solar irradiance of the water column occurring during the particular portion of the day;
a maximum potential for solar energy absorption within the water column occurring during the particular portion of the day; or
a maximum rate of temperature change associated with the water column occurring during the particular portion of the day.

15. The method of claim 1, further comprising:
determining, based on the time value of solar noon, an expected rate of change in one or more characteristics of the water column; and
determining one or more of the time interval or the second sampling periodicity based on the expected rate of change.

16. The method of any claim 1, wherein one or more of the plurality of sound velocity profile measurements are obtained using respective sampling periodicities that are shorter than the first sampling periodicity and longer than the second sampling periodicity.

17. The method of claim 1, further comprising:
processing the plurality of sonar measurements to generate a corresponding plurality of refraction corrected sonar measurements, wherein generating the corresponding plurality of refraction corrected sonar measurements includes:
processing a first subset of the plurality of sonar measurements using the first subset of the plurality of sound velocity profile measurements, to thereby generate a first subset of the corresponding plurality of refraction corrected sonar measurements; and
processing a second subset of the plurality of sonar measurements using the second subset of the plurality of sound velocity profile measurements, to thereby generate a second subset of the corresponding plurality of refraction corrected sonar measurements.

18. The method of claim 17, wherein:
the first subset of the plurality of sonar measurements and the first subset of the plurality of sound velocity profile measurements are obtained outside of the time interval; and
the second subset of the plurality of sonar measurements and the second subset of the plurality of sound velocity profile measurements are obtained within the time interval.

19. A system comprising:
at least one processor; and
a memory storing instructions which, when executed by the at least one processor, cause the at least one processor to:
obtain location information associated with one or more of a survey vessel or an acoustic survey associated with the survey vessel;
determine a time value of solar noon associated with the location information, wherein the time value of solar noon is determined based on the location information;
determine a time interval corresponding to increased water column heating from solar irradiance of a water column beneath the survey vessel, wherein the time interval is determined using one or more configured offsets from the time value of solar noon; and
perform the acoustic survey to obtain a plurality of sonar measurements and a plurality of sound velocity profile measurements within the water column, wherein:
a first subset of the plurality of sound velocity profile measurements is obtained outside of the time interval and using a first sampling periodicity; and
a second subset of the plurality of sound velocity profile measurements is obtained within the time interval and using a second sampling periodicity,
wherein the second sampling periodicity is shorter than the first sampling periodicity.

20. The system of claim 19, wherein the instructions further cause the at least one processor to:
compare a current time value to the determined time value of solar noon; and
control, based on the comparison, a winch system attached to the survey vessel and configured to deploy a towed sound velocity profiler (SVP) from the survey vessel into the water column,
wherein the instructions cause the at least one processor to control the winch system to:
deploy the towed SVP using the first sampling periodicity in response to the comparison indicating that the current time value is outside of the time interval; and
deploy the towed SVP using the second sampling periodicity in response to the comparison indicating that the current time value is within the time interval.
